(19) United States
(12) Patent Application Publication
(10) Pub. No.: US 2024/0365314 A1
(43) Pub. Date: Oct. 31, 2024

(54) METHOD OF WIRELESS COMMUNICATION, TERMINAL DEVICE AND NETWORK DEVICE

(71) Applicant: GUANGDONG OPPO MOBILE TELECOMMUNICATIONS CORP., LTD., Dongguan (CN)

(72) Inventors: Wenhong CHEN, Dongguan (CN); Zhihua SHI, Dongguan (CN)

(21) Appl. No.: 18/767,708

(22) Filed: Jul. 9, 2024

Related U.S. Application Data
(63) Continuation of application No. PCT/CN2022/074062, filed on Jan. 26, 2022.

(51) Int. Cl. H04W 72/1268; H04B 7/06; H04L 1/1812; H04L 5/00; H04W 52/36; H04W 72/51; H04W 76/28

(52) U.S. Cl. CPC H04W 72/1268; H04B 7/0626; H04L 1/1812; H04L 5/0051; H04W 52/365; H04W 72/51; H04W 76/28

(57) ABSTRACT

A method of wireless communication includes: receiving by a terminal device, a downlink signaling for scheduling a PUSCH; determining by the terminal device, transmit power of the transmission layers associated with the plurality of SRI information or the plurality of TCI states by using a target power control method; where the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states; and transmitting by the terminal device, the plurality of transmission layers according to determined transmit power of the plurality of transmission layers.

### CROSS-REFERENCE TO RELATED APPLICATION

This application is a Bypass Continuation Application of PCT/CN2022/074062 filed Jan. 26, 2022, which is incorporated herein by reference in its entirety.

### TECHNICAL FIELD

Embodiments of the present disclosure relate to the field of communication, and in particular, to a method of wireless communication, a terminal device, and a network device.

### BACKGROUND

A network device may schedule a terminal device to transmit a physical uplink shared channel (PUSCH) on a plurality of antenna panels, by single downlink control information (DCI), and at this time, different transmission layers of the PUSCH may be transmitted on different panels and transmitted to different transmission reception points (TRPs). The network device may configure different power control parameters for transmission layers on different panels, to ensure the reception performance of different transmission layers at different TRPs. Due to different hardware implementations, whether transmit power can be shared between different panels or whether coordinated power distribution is required between different panels, depends on specific implementations of various terminals. How terminals with different capabilities perform reasonable power control according to their own capabilities to ensure the transmission performance of uplink multi-panel, is a problem that needs to be solved.

### SUMMARY

In a first aspect, a method of wireless communication is provided, and the method includes:
receiving by a terminal device, a downlink signaling for scheduling a PUSCH; where the PUSCH includes a plurality of transmission layers, the downlink signaling includes a plurality of SRI information and the plurality of SRI information are associated with different transmission layers of the plurality of transmission layers, or the downlink signaling includes a plurality of TCI states and the plurality of TCI states are associated with different transmission layers of the plurality of transmission layers;
determining by the terminal device, transmit power of the transmission layers associated with the plurality of SRI information or the plurality of TCI states by using a target power control method; where the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states;
transmitting by the terminal device, the plurality of transmission layers according to determined transmit power of the plurality of transmission layers.

In a second aspect, a method of wireless communication is provided, and the method includes:
receiving by a network device, first capability information transmitted by a terminal device, where the first capability information is used to indicate whether transmit power is allowed to be shared between different antenna panels of the terminal device;
transmitting by the network device, configuration information to the terminal device according to the first capability information; where the configuration information is used to indicate that a first power control method or a second power control method is used for uplink power control, the first power control method is to determine the transmit power separately for transmission layers associated with a plurality of SRI information or a plurality of TCI states, and the second power control method is to determine the transmit power jointly for the transmission layers associated with the plurality of SRI information or the plurality of TCI states; where a downlink signaling for scheduling a PUSCH includes the plurality of SRI information or the plurality of TCI states, and the plurality of SRI information or the plurality of TCI states are associated with different transmission layers of a plurality of transmission layers of the PUSCH.

In a third aspect, a terminal device is provided for performing the method in the above first aspect.

In a possible implementation, the terminal device includes functional modules for performing the method in the above first aspect.

In a fourth aspect, a network device is provided for performing the method in the above second aspect.

In a possible implementation, the network device includes functional modules for performing the method in the above second aspect.

In a fifth aspect, a terminal device is provided, including a processor and a memory. The memory is configured to store a computer program, and the processor is configured to invoke and execute the computer program stored in the memory to perform the method in the above first aspect.

In a sixth aspect, a network device is provided, including a processor and a memory. The memory is configured to store a computer program, and the processor is configured to involve and execute the computer program stored in the memory, to perform the method in the above second aspect.

In a seventh aspect, an apparatus is provided for implementing the method of any one of the above first aspect to the second aspect.

In a possible implementation, the apparatus includes: a processor, configured to invoke and execute a computer program from a memory, to cause a device equipped with the apparatus to perform the method of any one of the above first aspect to the second aspect.

In an eighth aspect, a non-transitory computer readable storage medium is provided, for storing a computer program, where the computer program causes a computer to perform the method of any one of the above first aspect to the second aspect.

In a ninth aspect, a computer program product is provided, including a computer program instruction, where the computer program instruction causes a computer to perform the method of any one of the above first aspect to the second aspect.

In a tenth aspect, a computer program is provided, where the computer program, when being executed on a computer, causes the computer to perform the method of any one of the above first aspect to the second aspect.

### BRIEF DESCRIPTION OF THE DRAWINGS

FIG. 1 is a schematic diagram of a communication system architecture, applied by the embodiments of the present disclosure.

FIG. 2A is a schematic diagram of a PUSCH transmission based on multi-panel, provided by the present disclosure.

FIG. 2B is another schematic diagram of a PUSCH transmission based on multi-panel, provided by the present disclosure.

FIG. 3 is a schematic flowchart of a method of wireless communication, provided according to the embodiments of the present disclosure.

FIG. 4 is a schematic flowchart of another method of wireless communication, provided according to the embodiments of the present disclosure.

FIG. 5 is a schematic block diagram of a terminal device, provided according to the embodiments of the present disclosure.

FIG. 6 is a schematic block diagram of a network device, provided according to the embodiments of the present disclosure.

FIG. 7 is a schematic block diagram of a communication device, provided according to the embodiments of the present disclosure.

FIG. 8 is a schematic block diagram of an apparatus, provided according to the embodiments of the present disclosure.

FIG. 9 is a schematic block diagram of a communication system, provided according to the embodiments of the present disclosure.

### DETAILED DESCRIPTION

The technical solutions in the embodiments of the present disclosure will be described below in conjunction with the drawings in the embodiments of the present disclosure, and apparently, the described embodiments are a part of the embodiments of the present disclosure, but not all of the embodiments. For the embodiments of the present disclosure, all other embodiments obtained by the ordinary skilled in the art belong to the protection scope of the present disclosure.

The technical solutions of the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Networks (WLAN), Internet of Things (IoT), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc, and the embodiments of the present disclosure may also be applied to these communication systems.

In some embodiments, the communication system in the embodiments of the present disclosure may be applied to a carrier aggregation (CA) scenario, may also be applied to a dual connectivity (DC) scenario, and may also be applied to a standalone (SA) network deployment scenario, or applied to non-standalone (NSA) network deployment scenario.

In some embodiments, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

In some embodiments, the communication system in the embodiments of the present disclosure may be applied to an FR1 frequency band (corresponding to a frequency band range of 410 MHz to 7.125 GHZ), or may also be applied to an FR2 frequency band (corresponding to a frequency band range of 24.25 GHz to 52.6 GHZ), or may also be applied to a new frequency band, such as a high frequency band corresponding to a frequency band range of 52.6 GHz to 71 GHz or corresponding to a frequency band range of 71 GHz to 114.25 GHz.

The embodiments of the present disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present disclosure, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present disclosure, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), etc.

As an example but not a limitation, in the embodiments of the present disclosure, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a vehicle-mounted device, a wearable device, and a network device or a base station (gNB) in an NR network, or a network device in the PLMN network evolved in the future or a network device in the NTN network, etc.

As an example but not a limitation, in the embodiments of the present disclosure, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station provided on land, water, and other places.

In the embodiments of the present disclosure, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc, these small cells have characteristics of small coverage range and low transmit power, which are applicable for providing a data transmission service with high speed.

In the embodiments of the present disclosure, a method of wireless communication applicable to a terminal device is provided. The method includes:
receiving by a terminal device, a downlink signaling for scheduling a physical uplink shared channel (PUSCH); where the PUSCH includes a plurality of transmission layers, the downlink signaling includes a plurality of sounding reference signal resource indicator (SRI) information and the plurality of SRI information are associated with different transmission layers of the plurality of transmission layers, or the downlink signaling includes a plurality of transmission configuration indicator (TCI) states and the plurality of TCI states are associated with different transmission layers of the plurality of transmission layers;
determining by the terminal device, transmit power of the transmission layers associated with the plurality of SRI information or the plurality of TCI states by using a target power control method; where the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states; and
transmitting by the terminal device, the plurality of transmission layers according to determined transmit power of the plurality of transmission layers.

In a possible implementation of the method, reference signal resources indicated by the plurality of SRI information belong to different reference signal resource sets, or reference signal resources indicated by the plurality of TCI states belong to different reference signal resource sets.

In a possible implementation of the method, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information. Alternatively, in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

Optionally, the method may further include:
determining by the terminal device, the target power control method from the first power control method and the second power control method, according to a terminal capability of the terminal device.

In a possible implementation, determining by the terminal device, the target power control method from the first power control method and the second power control method, according to the terminal capability of the terminal device may include:
in a case where the transmit power is not allowed to be shared between different antenna panels of the terminal device, determining by the terminal device, that the target power control method is the first power control method; and/or
in a case where the transmit power is allowed to be shared between different antenna panels of the terminal device, determining by the terminal device, that the target power control method is the second power control method.

In another possible implementation, determining by the terminal device, the target power control method from the first power control method and the second power control method, according to the terminal capability of the terminal device may include:
in a case where a sum of maximum transmit power supported by the terminal device on a plurality of antenna panels on a carrier on which the PUSCH is located does not exceed maximum transmit power supported on the carrier, determining by the terminal device, that the target power control method is the first power control method; and/or
in a case where a sum of maximum transmit power supported by the terminal device on a plurality of antenna panels on a carrier on which the PUSCH is located exceeds maximum transmit power supported on the carrier, determining by the terminal device, that the target power control method is the second power control method.

Optionally, the method may further include:
determining by the terminal device, the target power control method from the first power control method and the second power control method, according to first indication information transmitted by a network device.

Optionally, before the terminal device receives the first indication information, the method further includes:
transmitting by the terminal device, first capability information to the network device, where the first capability information is used to indicate whether different antenna panels of the terminal device are allowed to share the transmit power.

Alternatively, before the terminal device receives the first indication information, the method further includes:
transmitting by the terminal device, second capability information to the network device;
where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, and maximum total transmit power supported by the terminal device on all antenna panels.

In a possible implementation, in a case where the target power control method is the first power control method, determining by the terminal device, the transmit power of the transmission layers associated with the plurality of SRI information or the plurality of TCI states by using the target power control method includes:
determining by the terminal device, the transmit power corresponding to each of the plurality of SRI information, according to a power control parameter corresponding to each of the plurality of SRI information, and maximum transmit power supported by each antenna panel on a carrier on which the PUSCH is located; and distributing evenly by the terminal device, the transmit power corresponding to each of the plurality of SRI information to transmission layers associated with each of the plurality of SRI information; or
determining by the terminal device, the transmit power corresponding to each of the plurality of TCI states, according to a power control parameter corresponding to each of the plurality of TCI states, and maximum transmit power supported by each antenna panel on a carrier on which the PUSCH is located; and distributing evenly by the terminal device, the transmit power corresponding to each of the plurality of TCI states to transmission layers associated with each of the plurality of TCI states.

In another possible implementation, in a case where the target power control method is the second power control method, determining by the terminal device, the transmit power of the transmission layers associated with the plurality of SRI information or the plurality of TCI states by using the target power control method includes:
determining by the terminal device, expected transmit power corresponding to each of the plurality of SRI information, according to a power control parameter corresponding to each of the plurality of SRI information and maximum transmit power supported on a carrier on which the PUSCH is located; and determining by the terminal device, the transmit power of transmission layers associated with different SRI information according to the maximum transmit power supported on the carrier and the expected transmit power corresponding to each of the plurality of SRI information; or
determining by the terminal device, expected transmit power corresponding to each of the plurality of TCI states, according to a power control parameter corresponding to each of the plurality of TCI states and maximum transmit power supported on a carrier on which the PUSCH is located; and determining by the terminal device, the transmit power of transmission layers associated with different TCI states according to the maximum transmit power supported on the carrier and the expected transmit power corresponding to each of the plurality of TCI states.

Optionally, in a case where a sum of the expected transmit power corresponding to the plurality of SRI information exceeds the maximum transmit power supported on the carrier, determining by the terminal device, the transmit power of the transmission layers associated with different SRI information according to the maximum transmit power supported on the carrier and the expected transmit power corresponding to each of the plurality of SRI information includes:
reducing by the terminal device, the expected transmit power corresponding to at least one of the plurality of SRI information according to a first preset rule, where a sum of transmit power corresponding to the plurality of SRI information after reducing the power does not exceed the maximum transmit power supported on the carrier; and distributing evenly by the terminal device, transmit power corresponding to each of the plurality of SRI information after the reducing, to transmission layers associated with each of the plurality of SRI information.

Alternatively, in a case where a sum of the expected transmit power corresponding to the plurality of TCI states exceeds the maximum transmit power supported on the carrier, determining by the terminal device, the transmit power of the transmission layers associated with different TCI states according to the maximum transmit power supported on the carrier and the expected transmit power corresponding to each of the plurality of TCI states includes:
reducing by the terminal device, the expected transmit power corresponding to at least one of the plurality of TCI states according to a first preset rule, where a sum of transmit power corresponding to the plurality of TCI states after reducing the power does not exceed the maximum transmit power supported on the carrier; and distributing evenly by the terminal device, the transmit power corresponding to each of the plurality of TCI states after the reducing, to transmission layers associated with each of the plurality of TCI states.

In a possible implementation, the first preset rule includes at least one of:
reducing lowest transmit power among the transmit power corresponding to the plurality of SRI information or the plurality of TCI states;
reducing highest transmit power among the transmit power corresponding to the plurality of SRI information or the plurality of TCI states;
if a transmission layer associated with first SRI information among the plurality of SRI information includes hybrid automatic repeat request-acknowledgement (HARQ-ACK) information or channel state information (CSI), and a transmission layer associated with second SRI information among the plurality of SRI information does not comprise the HARQ-ACK information or the CSI, reducing transmit power corresponding to the second SRI information;
if a transmission layer associated with a first TCI state among the plurality of TCI states includes the HARQ-ACK information or the CSI, and a transmission layer associated with a second TCI state among the plurality of TCI states does not comprise the HARQ-ACK information or the CSI, reducing transmit power corresponding to the second TCI state;
reducing the transmit power corresponding to the plurality of SRI information or the plurality of TCI states with a same ratio; or
reducing the transmit power corresponding to the plurality of SRI information or the plurality of TCI states with a same power value.

Optionally, the method further includes:
in a case where the transmit power of a transmission layer associated with one of the plurality of SRI information after reducing the transmit power is lower than a preset first threshold value, not transmitting by the terminal device, the PUSCH, or not transmitting by the terminal device, the transmission layer associated with the one of the plurality of SRI information.

Optionally, the method further includes:
in a case where the transmit power of a transmission layer associated with one of the plurality of TCI states after reducing the transmit power is lower than a preset first threshold value, not transmitting by the terminal device, the PUSCH, or not transmitting by the terminal device, the transmission layer associated with the one of the plurality of TCI states.

In a possible implementation, the first threshold value is configured by a network device, or the first threshold value is reported by the terminal device via a terminal capability to a network device.

In a possible implementation, determining by the terminal device, the transmit power of the transmission layers associated with different SRI information according to the maximum transmit power supported on the carrier and the expected transmit power corresponding to each of the plurality of SRI information includes:
determining by the terminal device, a minimum value among the expected transmit power corresponding to each of the plurality of SRI information and the maximum transmit power supported on the carrier, as actual transmit power of the PUSCH; and distributing evenly by the terminal device, the actual transmit power of the PUSCH to all transmission layers comprised in the PUSCH; or
determining by the terminal device, a smaller value between a maximum value among the expected transmit power corresponding to each of the plurality of SRI information and the maximum transmit power supported on the carrier, as actual transmit power of the PUSCH; and distributing evenly by the terminal device, the actual transmit power of the PUSCH to all transmission layers comprised in the PUSCH.

In a possible implementation, determining by the terminal device, the transmit power of the transmission layers associated with different TCI states according to the maximum transmit power supported on the carrier and the expected transmit power corresponding to each of the plurality of TCI states includes:
determining by the terminal device, a minimum value among the expected transmit power corresponding to each of the plurality of TCI states and the maximum transmit power supported on the carrier, as actual transmit power of the PUSCH; and distributing evenly by the terminal device, the actual transmit power of the PUSCH to all transmission layers comprised in the PUSCH; or
determining by the terminal device, a smaller value between a maximum value among the expected transmit power corresponding to each of the plurality of TCI states and the maximum transmit power supported on the carrier, as actual transmit power of the PUSCH; and distributing evenly by the terminal device, the actual transmit power of the PUSCH to all transmission layers comprised in the PUSCH.

Optionally, the method further includes:
performing by the terminal device, power headroom report (PHR) reporting for transmission layers associated with different SRI information of the plurality of SRI information, according to the target power control method; or
performing by the terminal device, PHR reporting for transmission layers associated with different TCI states of the plurality of TCI states, according to the target power control method.

In a possible implementation, in a case where the target power control method is the first power control method, performing by the terminal device, the power headroom report (PHR) reporting for the transmission layers associated with different SRI information of the plurality of SRI information, according to the target power control method includes: calculating by the terminal device, a power headroom (PH) value of a transmission layer associated with each of the plurality of SRI information, according to maximum transmit power supported by each antenna panel on a carrier on which the PUSCH is located, and transmit power of the transmission layer associated with each of the plurality of SRI information; reporting by the terminal device, PHRs of the transmission layers associated with the plurality of SRI information respectively.

In a possible implementation, in a case where the target power control method is the first power control method, performing by the terminal device, the PHR reporting for the transmission layers associated with different TCI states of the plurality of TCI states, according to the target power control method includes:
calculating by the terminal device, a PH value of a transmission layer associated with each of the plurality of TCI states according to maximum transmit power supported by each antenna panel on a carrier on which the PUSCH is located and transmit power of the transmission layer associated with each of the plurality of TCI states; reporting by the terminal device, PHRs of the transmission layers associated with the plurality of TCI states respectively.

In a possible implementation, in a case where the target power control method is the second power control method, performing by the terminal device, the PHR reporting for the transmission layers associated with different SRI information of the plurality of SRI information, according to the target power control method includes:
calculating by the terminal device, a PH value of a transmission layer associated with each of the plurality of SRI information, according to maximum transmit power supported on a carrier on which the PUSCH is located, and transmit power of the transmission layer associated with each of the plurality of SRI information; reporting by the terminal device, PHRs of the transmission layers associated with the plurality of SRI information respectively.

In a possible implementation, in a case where the target power control method is the second power control method, performing by the terminal device, the PHR reporting for the transmission layers associated with different TCI states of the plurality of TCI states, according to the target power control method, includes:
calculating by the terminal device, a PH value of a transmission layer associated with each of the plurality of TCI states, according to maximum transmit power supported on a carrier on which the PUSCH is located, and transmit power of the transmission layer associated with each of the plurality of TCI states; reporting by the terminal device, PHRs of the transmission layers associated with the plurality of TCI states respectively.

In a possible implementation of the method, the downlink signaling further includes a plurality of transmit power control (TPC) commands, the plurality of TPC commands correspond one-to-one with the plurality of SRI information or the plurality of TCI states, and the plurality of TPC commands are used to indicate power adjustment values of transmission layers associated with corresponding SRI information or TCI states.

Optionally, transmission layers associated with same SRI information use same transmit power, or transmission layers associated with a same TCI state use same transmit power, or transmission layers associated with a same phase tracking reference signal (PTRS) port use same transmit power.

In a possible implementation, transmitting by the terminal device, the plurality of transmission layers according to the determined transmit power of the plurality of transmission layers, includes:
transmitting by the terminal device, transmission layers associated with different SRI information or TCI states, on different antenna panels.

In the embodiments of the present disclosure, a method of wireless communication applicable to a network device is provides. The method includes:
receiving by the network device, first capability information transmitted by a terminal device, where the first capability information is used to indicate whether transmit power is allowed to be shared between different antenna panels of the terminal device;
transmitting by the network device, configuration information to the terminal device according to the first capability information; where the configuration information is used to indicate that a first power control method or a second power control method is used for uplink power control, the first power control method is to determine the transmit power separately for transmission layers associated with a plurality of sounding reference signal resource indicator (SRI) information or a plurality of transmission configuration indicator (TCI) states, and the second power control method is to determine the transmit power jointly for the transmission layers associated with the plurality of SRI information or the plurality of TCI states; where a downlink signaling for scheduling a physical uplink shared channel (PUSCH) includes the plurality of SRI information or the plurality of TCI states, and the plurality of SRI information or the plurality of TCI states are associated with different transmission layers of a plurality of transmission layers of the PUSCH.

In a possible implementation of the method, reference signal resources indicated by the plurality of SRI information belong to different reference signal resource sets, or reference signal resources indicated by the plurality of TCI states belong to different reference signal resource sets.

In a possible implementation of the method, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information. Alternatively, in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

In a possible implementation of the method, in a case where the first capability information indicates that the transmit power is allowed to be shared between different antenna panels of the terminal device, the network device configures the first power control method or the second power control method, or the network device only configures the second power control method. Alternatively, in a case where the first capability information indicates that the transmit power is not allowed to be shared between different antenna panels of the terminal device, the network device only configures the first power control method.

Optionally, the method further includes:
receiving by the network device, second capability information transmitted by the terminal device, where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, or maximum total transmit power supported by the terminal device on all antenna panels.

In a possible implementation of the method, in a case where a sum of maximum transmit power supported by the terminal device on a plurality of antenna panels on a carrier on which the PUSCH is located does not exceed maximum transmit power supported on the carrier, the network device only configures the first power control method. Alternatively, in a case where a sum of maximum transmit power supported by the terminal device on a plurality of antenna panels on a carrier on which the PUSCH is located exceeds maximum transmit power supported on the carrier, the network device configures the first power control method or the second power control method.

Exemplarily, the communication system 100 applied by the embodiments of the present disclosure is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and in some embodiments, the communication system 100 may include a plurality of network devices and may include another number of terminal devices within a coverage range of each network device, the embodiments of the present disclosure are not limited thereto.

In some embodiments, the communication system 100 may also include other network entities such as a network controller and a mobility management entity, etc., which are not limited to the embodiments of the present disclosure.

It should be understood that, in the embodiments of the present disclosure, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the specific devices described above, which will not be repeated herein; the communication device may also include other devices in the communication system 100, such as a network controller, a mobility management entity, and other network entities, which are not limited in the embodiments of the present disclosure.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the present document relates to a first communication device and a second communication device, and the first communication device may be a terminal device, such as a mobile phone, a machine facility, a customer premise equipment (CPE), an industrial device, a vehicle, etc; the second communication device may be a counterpart communication device of the first communication device, such as a network device, a mobile phone, an industrial device, a vehicle, etc. The first communication device as a terminal device and the second communication device as a network device, are taken as a specific instance herein.

The terms used in the implementation parts of the present disclosure are only used to explain specific embodiments of the present disclosure and are not intended to limit the present disclosure. The terms “first”, “second”, “third” and “fourth” etc., in the description, claims and drawings of the present disclosure are used to distinguish different objects rather than to describe a specific order. In addition, the terms “comprising” and “having” and any derivations thereof are intended to cover non-exclusive inclusion.

It should be understood that the “indication” mentioned in the embodiments of the present disclosure may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the present disclosure, “predefined” or “preconfigured” may be implemented by pre-saving corresponding codes, tables or other manners that may be used for indicating related information, in the device (for example, including the terminal device and the network device), and the present disclosure does not limit its specific implementation. For example, the predefined may refer to what is defined in a protocol.

In the embodiments of the present disclosure, the “protocol” may refer to a standard protocol in the field of communication, which may include, for example, an LTE protocol, an NR protocol, and related protocols applied in the future communication system, and the present disclosure is not limited thereto.

In order to facilitate the understanding of technical solutions of the embodiments of the present disclosure, the technical solutions of the present disclosure are described in detail below through specific embodiments. The following related technologies, as optional solutions, may be randomly combined with the technical solutions of the embodiments of the present disclosure, which all belong to the protection scope of the embodiments of the present disclosure. The embodiments of the present disclosure include at least some of the following contents.

In order to facilitate a better understanding of the embodiments of the present disclosure, a panel related to the present disclosure is described.

With the continuous evolution of an antenna packaging technology, a plurality of antenna elements may be nested and combined with a chip to form an antenna panel or an antenna array block, which makes it possible to configure a plurality of panels with low-correlation at a transmitter. Through a beamforming technology of multi-antenna, transmission signal energy is concentrated in a certain direction for transmission, which may effectively improve coverage, thereby improving the performance of communication. A plurality of panels may separately form transmission beams, and therefore, a terminal transmitter may transmit a data stream on the plurality of panels simultaneously by different beams, to improve the capacity or reliability of the transmission.

The terminal device needs to notify the network side of a number of configured antenna panels, in a capability report. At the same time, the terminal device may also need to notify the network side whether it has an ability to transmit signals on a plurality of antenna panels simultaneously. Since channel conditions corresponding to different panels are different, different panels need to adopt different transmission parameters according to their respective channel information. In order to obtain these transmission parameters, different sounding reference signal (SRS) resources need to be configured for different panels, to obtain uplink channel information. For example, in order to perform beam management for the uplink, an SRS resource set may be configured for each panel, so that the beam management is performed and a separate analog beam is determined, for each panel separately. In order to obtain precoding information used by a physical uplink shared channel (PUSCH) transmission, an SRS resource set may also be configured for each panel, to obtain a transmission parameter, such as a beam, a precoding vector, and a number of transmission layers, etc., used by a physical uplink control channel (PUCCH) transmitted on the panel. At the same time, the multi-panel transmission may also be applied to the PUCCH, that is, information carried by a same PUCCH resource or PUCCH resources on a same time domain resource may be transmitted to the network side by different panels, simultaneously.

In order to determine a panel used for transmitting a signal, the terminal may receive a plurality of reference signal resource sets configured by the network device, and different reference signal resource sets use different panels to transmit or receive a reference signal. For example, the network device may configure a plurality of channel state information reference signal (CSI-RS) resource sets, and different sets are received on different panels; or, the network device may configure a plurality of reference signal sets, and different sets are transmitted on different panels; or, the network device may indicate a plurality of physical cell identifiers (PCIs), and a synchronization signal block (SSB) associated with each PCI is used as a set, and thus different sets are received on different panels. At this time, each uplink signal may be associated with one reference signal set, or configured with a piece of reference signal indication information (such as transmission configuration indicator (TCI) state or sounding reference signal resource indicator (SRS resource indicator, SRI) information) to indicate a signal in a reference signal set, thereby using a transmitting or receiving panel of the associated reference signal set as a transmitting panel of the uplink signal. Or, the network device may configure a panel identity (ID) for each uplink signal, and determine the transmitting panel of the uplink signal according to the panel ID. Therefore, the uplink signals transmitted on different panels may be referred to as uplink signals associated with different reference signal resource sets, or uplink signals associated with different panel IDs. At this time, uplink signals associated with a same reference signal resource set, or uplink signals associated with a same panel ID, are transmitted by using a same panel.

It needs to be noted that an SSB may also be referred to as a synchronization signal/physical broadcast channel block (SS/PBCH block).

In order to facilitate a better understanding of the embodiments of the present disclosure, an uplink non-coherent transmission related to the present disclosure is described.

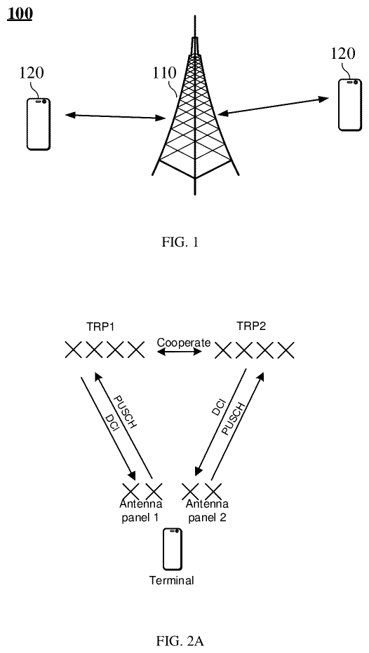

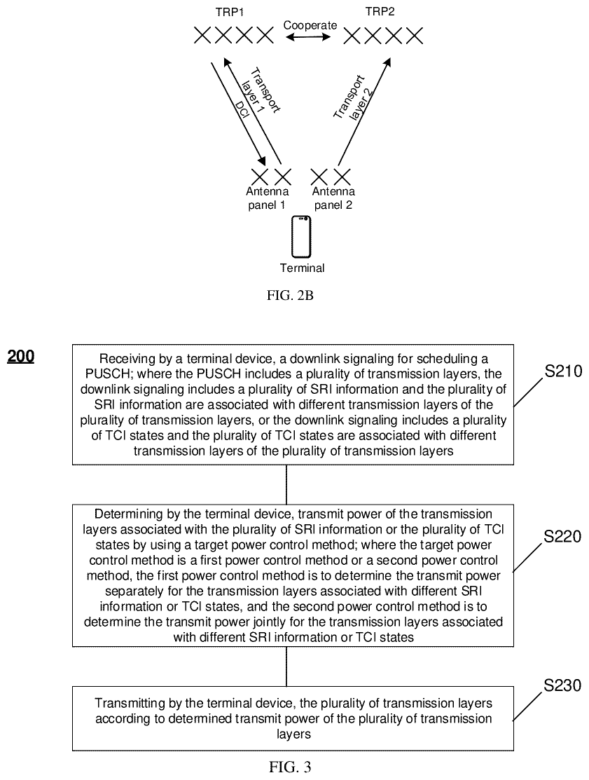

In the NR system, the uplink non-coherent transmission based on a plurality of transmission reception points (TRPs) is introduced. Herein, a backhaul connection between TRPs may be ideal or non-ideal, information may be exchanged quickly and dynamically between TRPs under ideal backhaul, and information may be exchanged just quasi-statically between TRPs under non-ideal backhaul due to a large latency. Different TRPs may also separately schedule PUSCH transmissions of a same terminal. Different PUSCH transmissions may be configured with separate transmission parameters, such as a beam, a precoding matrix, a number of layers, etc. The scheduled PUSCH transmissions may be transmitted on a same slot or on different slots. If the terminal is scheduled with a plurality of PUSCH transmissions at a same slot simultaneously, it needs to determine how to transmit according to its own capability. If the terminal is configured with a plurality of panels and supports the simultaneous transmission of the PUSCHs on the plurality of panels, the terminal may transmit the plurality of PUSCHs simultaneously, and the PUSCHs transmitted on different panels are aligned to the respective TRPs for analog forming, thereby distinguishing different PUSCHs by a spatial domain, and providing spectrum efficiency of the uplink (as shown in FIG. 2A). If the terminal only has a single panel, or does not support the simultaneous transmission of a plurality of panels, the terminal may transmit the PUSCHs only on one panel.

PUSCHs transmitted by different TRPs may be scheduled based on a plurality of downlink control information (DCI), and the DCI may be carried by different control resource sets (CORESETs). For example, a plurality of CORESET groups are configured at the network side, and each TRP schedules by using a CORESET in the respective CORESET group, that is, different TRPs may be distinguished by the CORESET groups. For example, the network device may configure a CORESET group index for each CORESET, and different indices correspond to different TRPs. PUSCHs transmitted to different TRPs may be also scheduled based on single DCI, and at this time, parameters such as beams and demodulation reference signal (DMRS) ports, etc., used respectively by the PUSCHs transmitted to different TRPs, need to be indicated in the DCI (as shown in FIG. 2B). In this way, different transmission layers of the PUSCH are transmitted by using separate transmission parameters (such as a beam, a precoding matrix, a power control parameter, etc.) on different panels, but a modulation and coding scheme (MCS) and a physical resource are the same.

It needs to be noted that FIGS. 2A and 2B show a PUSCH transmission based on the multi-panel, and specifically, FIG. 2A is based on a plurality of DCIs, and FIG. 2B is based on single DCI.

In order to facilitate a better understanding of the embodiments of the present disclosure, uplink PUSCH power control related to the present disclosure is described.

The transmit power of a PUSCH may be calculated by the following formula 1:

$${P}_{PUSCH , b , f , c} ( i , j , {q}_{d} , l ) = \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

where in the formula 1, P_{CMAX,f,c}(i) is maximum transmit power supported by the terminal on a carrier f on a serving cell c; i is an index of one PUSCH transmission; j is an open-loop power control parameter index (including target power P_{O_PUSCHb,f,c}(j) and a path loss factor α_{b,f,c}(j)); q_{d} is an index of a reference signal for path loss measurement, is used for obtaining a path loss value PL_{b,f,c}(q_{d}), and is also an open-loop power control parameter; f_{b,f,c}(i,l) is a closed-loop power control adjustment factor, where/is a closed-loop power control process. Herein, the terminal device determines the closed-loop power control adjustment factor according to a transmit power control (TPC) command transmitted by the network side, and the TPC command may be carried by a DCI used to schedule the PUSCH in a terminal search space, or by a DCI format 2_2 used to carry a group TPC command in a common search space.

In the NR system, the terminal device determines a transmitting beam of the scheduled PUSCH based on an SRI in the DCI, and also determines the power control parameter used by the PUSCH based on the SRI. In a possible implementation, the network side pre-configures a plurality of SRI-PUSCH-PowerControl parameter domains via a radio resource control (RRC) signaling, each parameter domain corresponds to an SRI value, and the parameter domain contains a group of PUSCH power control parameter configurations (such as j, q_{d}, l) corresponding to the SRI value. When the SRI indicates different values, the transmit power of the PUSCH currently scheduled is determined by using a power control parameter configuration in the corresponding parameter domain (SRI-PUSCH-PowerControl).

To facilitate a better understanding of the embodiments of the present disclosure, problems solved by the present disclosure are described.

The network device may schedule the PUSCH transmitted by the terminal on a plurality of panels, by single DCI, and at this time, different transmission layers of the PUSCH may be transmitted on different panels and transmitted to different TRPs. The network device may configure different power control parameters for the transmission layers on different panels, to ensure the reception performance of different transmission layers at different TRPs. Due to different hardware implementations, whether the transmit power can be shared between different panels or whether cooperated power distribution is required between the panels, depends on specific implementations of various terminals. How terminals with different capabilities perform reasonable power control to ensure the performance of the simultaneous transmission of the uplink multi-panel, is a problem that needs to be solved.

Based on the above problem, the present disclosure provides a solution for determining transmit power of a transmission layer, a corresponding power control method may be used according to whether the power can be shared between different panels or whether joint power distribution is required between different panels, to determine reasonable transmit power for transmission layers on each panel and perform corresponding PHR (Power Headroom Report) reporting, thereby ensuring the performance of the simultaneous transmission of the uplink multi-panel.

FIG. 3 is a schematic flowchart of a method 200 of wireless communication according to the embodiments of the present disclosure, and as shown in FIG. 3, the method 200 of wireless communication may include at least some of the following contents:
S210, receiving by a terminal device, a downlink signaling for scheduling a PUSCH; where the PUSCH includes a plurality of transmission layers, the downlink signaling includes a plurality of SRI information and the plurality of SRI information are associated with different transmission layers of the plurality of transmission layers, or the downlink signaling includes a plurality of TCI states and the plurality of TCI states are associated with different transmission layers of the plurality of transmission layers;
S220, determining by the terminal device, transmit power of the transmission layers associated with the plurality of SRI information or the plurality of TCI states by using a target power control method; where the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states;
S230, transmitting by the terminal device, the plurality of transmission layers according to determined transmit power of the plurality of transmission layers.

In the embodiments of the present disclosure, the “antenna panel” may also be referred to as an “antenna array block”, which is not limited thereto in the present disclosure.

In some embodiments, the downlink signaling may be a DCI signaling or an RRC signaling (such as a configured grant based on the PUSCH).

In some embodiments, the downlink signaling may also include both the plurality of SRI information and the plurality of TCI states, which is not limited thereto in the present disclosure.

In some embodiments, reference signal resources indicated by the plurality of SRI information belong to different reference signal resource sets. For example, SRS resources indicated by the plurality of SRI information belong to different SRS resource sets. The network device may pre-configure a plurality of SRS resource sets for the PUSCH, and each set is associated with one of the plurality of SRI information. In some embodiments, reference signal resources indicated by the plurality of TCI states belong to different reference signal resource sets. For example, CSI-RS resources indicated by the plurality of TCI states belong to different CSI-RS resource sets. The network device may pre-configure a plurality of CSI-RS resource sets for the PUSCH, and each set is associated with one of the TCI states.

In some embodiments, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information.

For example, assuming that the plurality of SRI information is 2, a number of the plurality of transmission layers is N. In a possible implementation, an association relationship between the plurality of SRI information and the plurality of transmission layers is as follows: the first N/2 (floor) transmission layers of the plurality of transmission layers are associated with one of the plurality of SRI information, and the last N/2 (ceil) transmission layers of the plurality of transmission layers are associated with another of the plurality of SRI information; or, odd-numbered layers of the plurality of transmission layers are associated with one of the plurality of SRI information, and even-numbered layers of the plurality of transmission layers are associated with another of the plurality of SRI information.

In some embodiments, in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

For example, assuming that the plurality of TCI states are 2 TCI states, and the number of the plurality of transmission layers is N, and an association relationship between the plurality of TCI states and the plurality of transmission layers is as follows: the first N/2 (floor) transmission layers of the plurality of transmission layers are associated with one of the TCI states, and the last N/2 (ceil) transmission layers of the plurality of transmission layers are associated with another of the TCI states; or, odd-numbered layers of the plurality of transmission layers are associated with one of the TCI states, and even-numbered layers of the plurality of transmission layers are associated with another of the TCI states.

In some embodiments, the downlink signaling includes two pieces of SRI information (a first SRI information and a second SRI information), where the first SRI information is associated with a first transmission layer (which may be one or more transmission layers), and the second SRI information is associated with a second transmission layer (which may be one or more transmission layers).

Herein, for the first power control method, the transmit power of the first transmission layer is determined according to a first power control parameter configured by the network device and maximum transmit power of the first transmission layer (that is, on a panel on which the first transmission layer is located), and is independent from the transmit power of the second transmission layer; the transmit power of the second transmission layer is determined according to a second power control parameter configured by the network device and maximum transmit power of the second transmission layer (that is, on a panel on which the second transmission layer is located), and is independent from the transmit power of the first transmission layer.

Herein, for the second power control method, the terminal device needs to determine actual transmit power of the first transmission layer and the second transmission layer, according to maximum transmit power on a carrier on which the PUSCH is located, the transmit power of the first transmission layer calculated based on the first power control parameter, and the transmit power of the second transmission layer calculated based on the second power control parameter. That is, the transmit power of the first transmission layer and the second transmission layer needs to be determined jointly, and when determining the actual transmit power of the first transmission layer, the transmit power of the second transmission layer also needs to be considered.

For the terminal device where the power can be shared between panels, may only limit total transmit power, and at this time, the terminal may prioritize distributing the power to a panel that needs more power according to the transmit power on two panels, thereby achieving better transmission performance. If a sum of maximum transmit power of a plurality of panels on a carrier exceeds maximum transmit power supported on the carrier, it is also necessary to use the second power control method to distribute the power among transmission layers of the plurality of panels.

In some embodiments, the terminal device determines the target power control method from the first power control method and the second power control method according to a terminal capability of the terminal device.

In some implementations, in a case where the transmit power is not allowed to be shared between different antenna panels of the terminal device, the terminal device determines that the target power control method is the first power control method; and/or in a case where the transmit power is allowed to be shared between different antenna panels of the terminal device, the terminal device determines that the target power control method is the second power control method. Optionally, whether the transmit power can be shared between different antenna panels of the terminal device may be reported to the network device, so that the network device may know the power control method used by the terminal device.

In some other implementations, if the power can not be shared between different panels of the terminal device, the first power control method is used; if the power can be shared between different panels of the terminal, the first power control method or the second power control method may be used. Which method to use may be configured by the network device, or determined by the terminal device and then reported to the network device.

In some other implementations, in a case where a sum of maximum transmit power supported by the terminal device on a plurality of antenna panels on a carrier on which the PUSCH is located does not exceed maximum transmit power supported on the carrier, the terminal device determines that the target power control method is the first power control method; and/or in a case where a sum of maximum transmit power supported by the terminal device on a plurality of antenna panels on a carrier on which the PUSCH is located exceeds maximum transmit power supported on the carrier, the terminal device determines that the target power control method is the second power control method.

For example, if the sum of the maximum transmit power supported by the terminal device on a plurality of panels on a carrier on which the PUSCH is located does not exceed the maximum transmit power supported on the carrier, the first power control method is used. If the sum of the maximum transmit power supported by the terminal device on the plurality of panels on a carrier on which the PUSCH is located exceeds the maximum transmit power supported on the carrier, the second power control method is used. Assuming that the maximum transmit power supported on a first panel is P_{c, 1, max}, the maximum transmit power supported on a second panel is P_{c, 2, max}, and the maximum transmit power supported by the terminal on the carrier is P_{c, max}, then when P_{c, 1, max}+P_{c, 2, max}<=P_{c, max}, the first power control method is used; when P_{c, 1, max}+P_{c, 2, max}>P_{c, max}, the second power control method is used.

In some embodiments, the terminal device determines the target power control method from the first power control method and the second power control method according to first indication information transmitted by the network device. Optionally, the first indication information may be carried by a high layer signaling.

For example, the network device indicates a power control method currently used by the terminal device via the high layer signaling. For another example, the terminal device may only use the first power control method by default, and the network device may enable the second power control method via a downlink signaling, and when the terminal device receives the signaling, it uses the second power control method.

In some embodiments, before the terminal device receives the first indication information, the terminal device transmits first capability information to the network device, where the first capability information is used to indicate whether different antenna panels of the terminal device are allowed to share the transmit power.

In a possible implementation, the network device may determine which power control method to use according to the first capability information. If the first capability information indicates that the power can be shared, the network device may configure the second power control method or the first power control method, or may only configure the second power control method (at this time, the terminal device does not expect that the network device configures the first power control method); if the first capability information indicates that the power can not be shared, the network device may only configure the first power control method (at this time, the terminal device does not expect that the network device configures the second power control method).

In some embodiments, before the terminal device receives the first indication information, the terminal device transmits second capability information to the network device, where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, or maximum total transmit power supported by the terminal device on all antenna panels.

For example, the maximum total transmit power supported on one panel herein refers to a total of maximum transmit power supported by one panel on all carriers, and the maximum total transmit power supported by the terminal device on all panels is a maximum total of transmit power that the terminal device can support on all panels and on the carrier on which the PUSCH is located, that is, the maximum transmit power supported by the terminal device (i.e., the transmit power determined by a power class of the terminal device). The second capability information may be used by the terminal device to calculate the transmit power of the transmission layers associated with different SRI information (or TCI states) under the first power control method.

In some implementations, the second capability information may be reported to the network together with the first capability information.

In one implementation, the terminal device reports the second capability information only when the first capability information reported by the terminal device indicates that the power can not be shared between different panels of the terminal device.

In some embodiments, in an example 1, in a case where the target power control method is the first power control method, the above S220 may include:
determining by the terminal device, the transmit power corresponding to each of the plurality of SRI information, according to a power control parameter corresponding to each of the plurality of SRI information, and maximum transmit power supported by each antenna panel on a carrier on which the PUSCH is located; and distributing evenly by the terminal device, the transmit power corresponding to each of the plurality of SRI information to transmission layers associated with each of the plurality of SRI information; or
determining by the terminal device, the transmit power corresponding to each of the plurality of TCI states, according to a power control parameter corresponding to each of the plurality of TCI states, and maximum transmit power supported by each antenna panel on a carrier on which the PUSCH is located; and distributing evenly by the terminal device, the transmit power corresponding to each of the plurality of TCI states to transmission layers associated with each of the plurality of TCI states.

In some embodiments, in an example 2, in a case where the target power control method is the second power control method, the above S220 may include:
determining by the terminal device, expected transmit power corresponding to each of the plurality of SRI information, according to a power control parameter corresponding to each of the plurality of SRI information and maximum transmit power supported on a carrier on which the PUSCH is located; and determining by the terminal device, the transmit power of transmission layers associated with different SRI information according to the maximum transmit power supported on the carrier and the expected transmit power corresponding to each of the plurality of SRI information; or
determining by the terminal device, expected transmit power corresponding to each of the plurality of TCI states, according to a power control parameter corresponding to each of the plurality of TCI states and maximum transmit power supported on a carrier on which the PUSCH is located; and determining by the terminal device, the transmit power of transmission layers associated with different TCI states according to the maximum transmit power supported on the carrier on which the PUSCH is located and the expected transmit power corresponding to each of the plurality of TCI states.

In some implementations, in the example 2, in a case where a sum of the expected transmit power corresponding to the plurality of SRI information exceeds the maximum transmit power supported on the carrier on which the PUSCH is located, the terminal device reduces the expected transmit power corresponding to at least one of the plurality of SRI information according to a first preset rule, where a sum of transmit power corresponding to the plurality of SRI information after reducing the power does not exceed the maximum transmit power supported on the carrier on which the PUSCH is located; and the terminal device distributes evenly transmit power corresponding to each of the plurality of SRI information after the reducing, to transmission layers associated with each of the plurality of SRI information.

In some implementations, in the example 2, in a case where a sum of the expected transmit power corresponding to the plurality of TCI states exceeds the maximum transmit power supported on the carrier on which the PUSCH is located, the terminal device reduces the expected transmit power corresponding to at least one of the plurality of TCI states according to a first preset rule, where a sum of transmit power corresponding to the plurality of TCI states after reducing the power does not exceed the maximum transmit power supported on the carrier on which the PUSCH is located; and the terminal device distributes evenly the transmit power corresponding to each of the plurality of TCI states after the reducing, to transmission layers associated with each of the plurality of TCI states.

In some implementations, the first preset rule includes at least one of:
reducing lowest transmit power among the transmit power corresponding to the plurality of SRI information or the plurality of TCI states;
reducing highest transmit power among the transmit power corresponding to the plurality of SRI information or the plurality of TCI states;
if a transmission layer associated with first SRI information among the plurality of SRI information includes hybrid automatic repeat request-acknowledgement (HARQ-ACK) information or channel state information (CSI), and a transmission layer associated with second SRI information among the plurality of SRI information does not include the HARQ-ACK information or the CSI, reducing transmit power corresponding to the second SRI information;
if a transmission layer associated with a first TCI state among the plurality of TCI states includes the HARQ-ACK information or the CSI, and a transmission layer associated with a second TCI state among the plurality of TCI states does not include the HARQ-ACK information or the CSI, reducing transmit power corresponding to the second TCI state;
reducing the transmit power corresponding to the plurality of SRI information or the plurality of TCI states with a same ratio; or
reducing the transmit power corresponding to the plurality of SRI information or the plurality of TCI states with a same power value.

In some implementations, the first preset rule at least includes: reducing the lowest transmit power among the transmit power corresponding to the plurality of SRI information or the plurality of TCI states. For example, the lowest transmit power among the transmit power corresponding to the plurality of SRI information or the plurality of TCI states is reduced, that is, higher transmit power is not changed, thereby ensuring the transmission reliability of at least a part of the transmission layers. Furthermore, if the lowest transmit power reaches a certain threshold value after the power reduction, the transmit power will not continue to be reduced, and the second lowest transmit power will be reduced, thereby ensuring that the transmit power corresponding to each of the SRI information or the TCI states has a minimum value that can support the transmission.

In some implementations, the first preset rule at least includes: reducing the highest transmit power among the transmit power corresponding to the plurality of SRI information or the plurality of TCI states. For example, the highest transmit power among the transmit power corresponding to the plurality of SRI information or the plurality of TCI states is reduced, that is, lower transmit power is not changed, thereby ensuring that the transmission performance of all layers is similar. Furthermore, if the highest transmit power is reduced to the same as transmit power corresponding to another piece of SRI information or another TCI state, transmit power corresponding to these two pieces of SRI information or two TCI states is reduced with a same ratio or a same power value. For example, after a first transmit power is reduced to the same as a second transmit power, if the transmit power still needs to be reduced, these two pieces of transmit power are reduced simultaneously, to ensure that the first transmit power is not less than the second transmit power after the power reduction, that is, only the currently highest transmit power is always reduced.

In some implementations, the first preset rule at least includes: if a transmission layer associated with first SRI information among the plurality of SRI information includes the HARQ-ACK information or the CSI, and a transmission layer associated with second SRI information among the plurality of SRI information does not include the HARQ-ACK information or the CSI, reducing transmit power corresponding to the second SRI information. For example, if the transmission layer associated with the first SRI information contains the HARQ-ACK information or the CSI, and the transmission layer associated with the second SRI information does not contain the HARQ-ACK information and the CSI, the transmit power corresponding to the second SRI information is reduced.

For example, if the transmission layer associated with the first SRI information contains the HARQ-ACK information, and the transmission layer associated with the second SRI information does not contain the HARQ-ACK information, the transmit power corresponding to the second SRI information is reduced.

For another example, if the transmission layer associated with the first SRI information contains the CSI, and the transmission layer associated with the second SRI information does not contain the CSI, the transmit power corresponding to the second SRI information is reduced.

In some implementations, the first preset rule at least includes: if a transmission layer associated with a first TCI state among the plurality of TCI states includes the HARQ-ACK information or the CSI, and a transmission layer associated with a second TCI state among the plurality of TCI states does not include the HARQ-ACK information or the CSI, reducing transmit power corresponding to the second TCI state. For example, if the transmission layer associated with the first TCI state contains the HARQ-ACK information or the CSI, and the transmission layer associated with the second TCI state does not contain the HARQ-ACK information and the CSI, the transmit power corresponding to the second TCI state is reduced.

For example, if the transmission layer associated with the first TCI state contains the HARQ-ACK information, and the transmission layer associated with the second TCI state does not contain the HARQ-ACK information, the transmit power corresponding to the second TCI state is reduced.

For another example, if the transmission layer associated with the first TCI state contains the CSI, and the transmission layer associated with the second TCI state does not contain the CSI, the transmit power corresponding to the second TCI state is reduced.

In some implementations, the first preset rule at least includes: reducing the transmit power corresponding to the plurality of SRI information or the plurality of TCI states with a same ratio. For example, the transmit power corresponding to the plurality of TCI states is reduced with the same ratio.

In a possible implementation, assuming that the expected transmit power of the plurality of panels is P1 and P2 respectively, the maximum transmit power supported by the terminal device on the carrier on which the PUSCH is located, is Pₘₐₓ. In a case where P1+P2>Pₘₐₓ and signal priorities on the plurality of panels are the same, equally proportional reduction of the power on the plurality of panels is: P1*Pₘₐₓ/(P1+P2) and P2*Pₘₐₓ/(P1+P2), respectively.

In some implementations, the first preset rule at least includes: reducing the transmit power corresponding to the plurality of SRI information or the plurality of TCI states with a same power value. For example, the transmit power corresponding to the plurality of TCI states is reduced with the same power value.

In a possible implementation, assuming that the current transmit power of the PUSCH is P₂, the target transmit power is P₃ (P₃<P₂), and the DCI contains K TCI states, the transmit power corresponding to each TCI state needs to be reduced by (P₃−P₂)/K.

In some embodiments, in a case where the transmit power of a transmission layer associated with one of the plurality of SRI information after reducing the transmit power is lower than a preset first threshold value, the terminal device does not transmit the PUSCH, or the terminal device does not transmit the transmission layer associated with the one of the plurality of SRI information.

In some implementations, in a case where the transmit power of a transmission layer associated with one of the plurality of TCI states after reducing the transmit power is lower than a preset first threshold value, the terminal device does not transmit the PUSCH, or the terminal device does not transmit the transmission layer associated with the one of the plurality of TCI states.

In some implementations, the first threshold value is configured by a network device, or the first threshold value is reported by the terminal device via a terminal capability to a network device.

In a possible implementation, the first threshold value may be an absolute value of transmit power (e.g., X dBm), or the first threshold value is a ratio value (i.e., a value between 0 and 1) of the transmit power with respect to the maximum transmit power supported on one carrier.

In some implementations, in the example 2, the terminal device determines a minimum value among the expected transmit power corresponding to each of the plurality of SRI information and the maximum transmit power supported on the carrier, as actual transmit power of the PUSCH; and the terminal device distributes evenly the actual transmit power of the PUSCH to all transmission layers included in the PUSCH.

In some implementations, in the example 2, the terminal device determines a smaller value between a maximum value among the expected transmit power corresponding to each of the plurality of SRI information and the maximum transmit power supported on the carrier, as actual transmit power of the PUSCH; and the terminal device distributes evenly the actual transmit power of the PUSCH to all transmission layers included in the PUSCH.

In some implementations, in the example 2, the terminal device determines a minimum value among the expected transmit power corresponding to each of the plurality of TCI states and the maximum transmit power supported on the carrier, as actual transmit power of the PUSCH; and the terminal device distributes evenly the actual transmit power of the PUSCH to all transmission layers included in the PUSCH.

In some implementations, in example 2, the terminal device determines a smaller value between a maximum value among the expected transmit power corresponding to each of the plurality of TCI states and the maximum transmit power supported on the carrier, as actual transmit power of the PUSCH; and the terminal device distributes evenly the actual transmit power of the PUSCH to all transmission layers included in the PUSCH.

In some embodiments, the terminal device performs power headroom report (PHR) reporting for transmission layers associated with different SRI information of the plurality of SRI information, according to the target power control method; or the terminal device performs PHR reporting for transmission layers associated with different TCI states of the plurality of TCI states, according to the target power control method.

In some embodiments, in a case where the target power control method is the first power control method, the terminal device calculates a power headroom (PH) value of a transmission layer associated with each of the plurality of SRI information, according to maximum transmit power supported by each antenna panel on a carrier on which the PUSCH is located, and transmit power of the transmission layer associated with each of the plurality of SRI information; the terminal device reports PHRs of the transmission layers associated with the plurality of SRI information respectively.

In some embodiments, in a case where the target power control method is the first power control method, the terminal device calculates a PH value of a transmission layer associated with each of the plurality of TCI states according to maximum transmit power supported by each antenna panel on a carrier on which the PUSCH is located and transmit power of the transmission layer associated with each of the plurality of TCI states; the terminal device reports PHRs of the transmission layers associated with the plurality of TCI states respectively.

In a possible implementation, the terminal device may calculate a PH value of a transmission layer associated with each of the plurality of TCI states based on the maximum transmit power supported on the carrier on which the PUSCH is located and the transmit power of the transmission layer associated with each of the plurality of TCI states; furthermore, the terminal device may report the PHRs of the transmission layers associated with the plurality of TCI states, respectively.

For example, assuming that transmit power of a first transmission layer associated with a first TCI state is P₁, transmit power of a second transmission layer associated with a second TCI state is P₂, and the maximum transmit power supported by the terminal device on the carrier on which the PUSCH is located, is P_{c, max}, then the PH value corresponding to the first transmission layer is P_{c, max}−P₁, and the PH value corresponding to the second transmission layer is P_{c, max}−P₂.

In some embodiments, in a case where the target power control method is the second power control method, the terminal device calculates a PH value of a transmission layer associated with each of the plurality of SRI information, according to maximum transmit power supported on a carrier on which the PUSCH is located, and transmit power of the transmission layer associated with each of the plurality of SRI information; the terminal device reports PHRs of the transmission layers associated with the plurality of SRI information respectively.

In a possible implementation, the terminal device may calculate a PH value of a transmission layer associated with each of the plurality of SRI information, based on the maximum transmit power supported on the carrier on which the PUSCH is located, and the transmit power of the transmission layer associated with each of the plurality of SRI information; furthermore, the terminal device may report the PHRs of the transmission layers associated with the plurality of SRI information respectively.

For example, assuming that transmit power of a first transmission layer associated with first SRI information is P₁, transmit power of a second transmission layer associated with second SRI information is P₂, and the maximum transmit power supported by the terminal device on the carrier on which the PUSCH is located, is P_{c, max}, then the PH value corresponding to the first transmission layer is P_{c, max}−P₁, and the PH value corresponding to the second transmission layer is P_{c, max}−P₂.

In some embodiments, in a case where the target power control method is the second power control method, the terminal device calculates a PH value of a transmission layer associated with each of the plurality of TCI states, according to maximum transmit power supported on a carrier on which the PUSCH is located, and transmit power of the transmission layer associated with each of the plurality of TCI states; the terminal device reports PHRs of the transmission layers associated with the plurality of TCI states respectively.

In some embodiments, the downlink signaling further includes a plurality of transmit power control (TPC) commands, the plurality of TPC commands correspond one-to-one with the plurality of SRI information or the plurality of TCI states, and the plurality of TPC commands are used to indicate power adjustment values of transmission layers associated with corresponding SRI information or TCI states.

For example, the downlink signaling further includes a plurality of TPC commands, the plurality of TPC commands correspond one-to-one with the plurality of SRI information, and the plurality of TPC commands are used to indicate closed-loop power adjustment values of transmission layers associated with the corresponding SRI information. For example, the downlink signaling is the DCI, where the DCI contains a first TPC command and a second TPC command, the first TPC command corresponds to a first TCI state and is used to indicate a closed-loop power adjustment value of a first transmission layer; the second TPC command corresponds to a second TCI state and is used to indicate a closed-loop power adjustment value of a second transmission layer.

In some embodiments, transmission layers associated with same SRI information use same transmit power, or transmission layers associated with a same TCI state use same transmit power, or transmission layers associated with a same phase tracking reference signal (PTRS) port use same transmit power.

In some embodiments, the above S230 may include:
transmitting by the terminal device, transmission layers associated with different SRI information or TCI states, on different antenna panels.

Therefore, in the embodiments of the present disclosure, the terminal device may determine the transmit power of transmission layers associated with the plurality of SRI information or the plurality of TCI states, by using the power control method for determining the transmit power separately for transmission layers associated with different SRI information or TCI states, or the terminal device may determine the transmit power of transmission layers associated with the plurality of SRI information or the plurality of TCI states, by using the power control method for determining the transmit power jointly for transmission layers associated with different SRI information or TCI states, so as to ensure the reception performance of different transmission layers on different TRPs. Furthermore, the power control method to be used may be determined based on whether the transmit power is allowed to be shared between different antenna panels, or whether joint power distribution is allowed between different antenna panels, so that terminals with different capabilities can perform the reasonable power control, and the reasonable transmit power is determined for the transmission layer on each panel, to ensure the transmission performance of the uplink multi-panel.

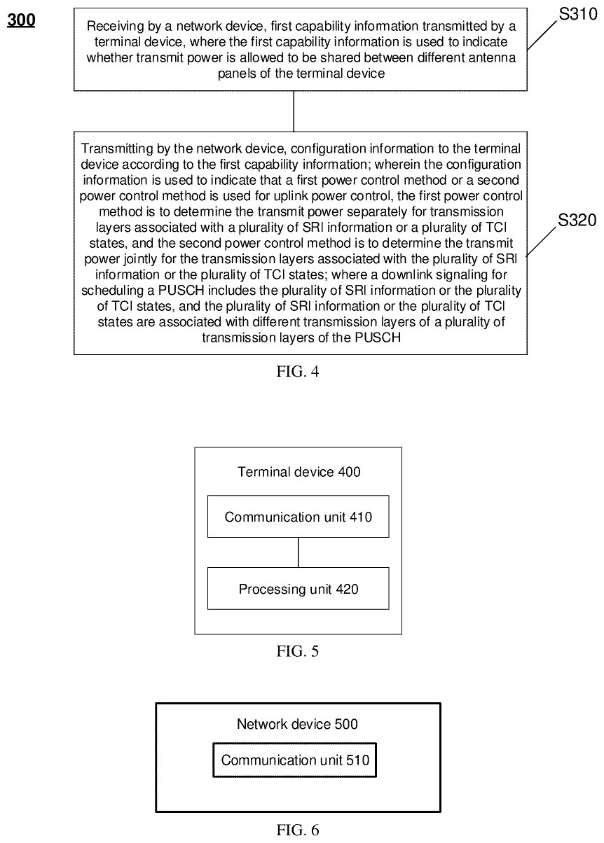

The terminal side embodiments of the present disclosure are described in detail above with reference to FIG. 3, and network side embodiments of the present disclosure are described in detail below with reference to FIG. 4, and it should be understood that the network side embodiments and the terminal side embodiments correspond to each other and the similar description may refer to the terminal side embodiments.

FIG. 4 is a schematic flowchart of a method 300 of wireless communication according to the embodiments of the present disclosure, and as shown in FIG. 4, the method 300 of wireless communication may include at least some of the following contents:
S310, receiving by a network device, first capability information transmitted by a terminal device, where the first capability information is used to indicate whether transmit power is allowed to be shared between different antenna panels of the terminal device;
S320, transmitting by the network device, configuration information to the terminal device according to the first capability information; where the configuration information is used to indicate that a first power control method or a second power control method is used for uplink power control, the first power control method is to determine the transmit power separately for transmission layers associated with a plurality of SRI information or a plurality of TCI states, and the second power control method is to determine the transmit power jointly for the transmission layers associated with the plurality of SRI information or the plurality of TCI states; where a downlink signaling for scheduling a PUSCH includes the plurality of SRI information or the plurality of TCI states, and the plurality of SRI information or the plurality of TCI states are associated with different transmission layers of a plurality of transmission layers of the PUSCH.

In the embodiments of the present disclosure, the “antenna panel” may also be referred to as an “antenna array block”, which is not limited thereto in the present disclosure.

In some embodiments, the downlink signaling may be a DCI signaling or an RRC signaling (such as a configured grant based on the PUSCH).

In some embodiments, the downlink signaling may also include both the plurality of SRI information and the plurality of TCI states, which is not limited thereto in the present disclosure.

In some embodiments, reference signal resources indicated by the plurality of SRI information belong to different reference signal resource sets. For example, SRS resources indicated by the plurality of SRI information belong to different SRS resource sets. The network device may pre-configure a plurality of SRS resource sets for the PUSCH, and each set is associated with one of the plurality of SRI information.

In some embodiments, reference signal resources indicated by the plurality of TCI states belong to different reference signal resource sets. For example, CSI-RS resources indicated by the plurality of TCI states belong to different CSI-RS resource sets. The network device may pre-configure a plurality of CSI-RS resource sets for the PUSCH, and each set is associated with one of the TCI states.

In some embodiments, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information.

For example, assuming that the plurality of SRI information is 2, a number of the plurality of transmission layers is N. An association relationship between the plurality of SRI information and the plurality of transmission layers is as follows: the first N/2 (floor) transmission layers of the plurality of transmission layers are associated with one of the plurality of SRI information, and the last N/2 (ceil) transmission layers of the plurality of transmission layers are associated with another of the plurality of SRI information; or, odd-numbered layers of the plurality of transmission layers are associated with one of the plurality of SRI information, and even-numbered layers of the plurality of transmission layers are associated with another of the plurality of SRI information.

In some embodiments, in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

For example, assuming that the plurality of TCI states are 2 TCI states, and the number of the plurality of transmission layers is N, and an association relationship between the plurality of TCI states and the plurality of transmission layers is as follows: the first N/2 (floor) transmission layers of the plurality of transmission layers are associated with one of the TCI states, and the last N/2 (ceil) transmission layers of the plurality of transmission layers are associated with another of the TCI states; or, odd-numbered layers of the plurality of transmission layers are associated with one of the TCI states, and even-numbered layers of the plurality of transmission layers are associated with another of the TCI states.

In some embodiments, in a case where the first capability information indicates that the transmit power is allowed to be shared between different antenna panels of the terminal device, the network device configures the first power control method or the second power control method, or the network device only configures the second power control method.

In some embodiments, in a case where the first capability information indicates that the transmit power is not allowed to be shared between different antenna panels of the terminal device, the network device only configures the first power control method.

In some embodiments, the network device receives second capability information transmitted by the terminal device, where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, or maximum total transmit power supported by the terminal device on all antenna panels.

In some embodiments, in a case where a sum of maximum transmit power supported by the terminal device on a plurality of antenna panels on a carrier on which the PUSCH is located does not exceed maximum transmit power supported on the carrier, the network device only configures the first power control method.

In some embodiments, in a case where a sum of maximum transmit power supported by the terminal device on a plurality of antenna panels on a carrier on which the PUSCH is located exceeds maximum transmit power supported on the carrier, the network device configures the first power control method or the second power control method.

Therefore, in the embodiments of the present disclosure, the network device may indicate the power control method used by the terminal device based on whether the transmit power is allowed to be shared between different antenna panels, or whether joint power distribution is allowed between different antenna panels, so that terminals with different capabilities may perform the reasonable power control, determine the reasonable transmit power for the transmission layer on each panel, and thus ensure the transmission performance of the uplink multi-panel. For example, the terminal device may determine the transmit power of transmission layers associated with the plurality of SRI information or the plurality of TCI states, by using the power control method for determining the transmit power separately for transmission layers associated with different SRI information or TCI states, or the terminal device may determine the transmit power of transmission layers associated with the plurality of SRI information or the plurality of TCI states, by using the power control method for determining the transmit power jointly for transmission layers associated with different SRI information or TCI states, so as to ensure the reception performance of different transmission layers on different TRPs.

The technical solutions of the present disclosure are described in detail by Embodiment 1 to Embodiment 3 below.

Embodiment 1, the transmit power of the transmission layer may be determined and the transmission layer may be transmitted, for example, by S11 to S14.

S11, the terminal device receives a downlink signaling for scheduling a PUSCH.

Herein, the downlink signaling may be a DCI signaling or an RRC signaling (such as a configured grant based on the PUSCH). This embodiment takes the DCI signaling as an example.

Herein, the downlink signaling contains a plurality of SRI information or a plurality of TCI states. In this embodiment, the plurality of SRI information is taken as an example (the SRI information in the following description may also be replaced with the TCI state). The PUSCH includes a plurality of transmission layers (assuming that N>1 transmission layers, herein), and the plurality of SRI information are associated with different transmission layers of the plurality of transmission layers (that is, different SRI information is associated with different transmission layers).

In a possible implementation, an association relationship between the SRI information and the transmission layer may be configured by the network device to the terminal device, or the association relationship between the SRI information and the transmission layer may be pre-agreed by the terminal device and the network device.

In some implementations, assuming that the plurality of SRI information is 2 pieces of SRI information, the association relationship between the plurality of SRI information and the plurality of transmission layers is: first N/2 (floor) transmission layers of the plurality of transmission layers are associated with one of the plurality of SRI information, and last N/2 (ceil) transmission layers of the plurality of transmission layers are associated with another of the plurality of SRI information.

In some implementations, other association methods may also be used, for example, odd-numbered layers of the plurality of transmission layers are associated with one of the plurality of SRI information and even-numbered layers of the plurality of transmission layers are associated with another of the plurality of SRI information.

In some implementations, reference signal resources indicated by the plurality of SRI information belong to different reference signal resource sets. For example, SRS resources indicated by the plurality of SRI information belong to different SRS resource sets. The network device may pre-configure a plurality of SRS resource sets for the PUSCH, and each set is associated with one of the plurality of SRI information.

S12, the terminal device determines whether a first power control method or a second power control method is used to determine the transmit power of transmission layers associated with the plurality of SRI information, according to indication information of the network device or according to its own UE capability.

Herein, the first power control method is to determine the transmit power separately for the transmission layers associated with different SRI information, and the second power control method is to determine the transmit power jointly for the transmission layers associated with different SRI information.

For example, assuming that the DCI contains two pieces of SRI information (a first SRI information and a second SRI information), where the first SRI information is associated with a first transmission layer, and the second SRI information is associated with a second transmission layer.

Herein, for the first power control method, the transmit power of the first transmission layer is determined according to a first power control parameter configured by the network device and maximum transmit power of the first transmission layer (that is, on a panel on which the first transmission layer is located), and is independent from the transmit power of the second transmission layer; the transmit power of the second transmission layer is determined according to a second power control parameter configured by the network device and maximum transmit power of the second transmission layer (that is, on a panel on which the second transmission layer is located), and is independent from the transmit power of the first transmission layer.

Herein, for the second power control method, the terminal device needs to determine actual transmit power of the first transmission layer and the second transmission layer, according to maximum transmit power on a carrier on which the PUSCH is located, the transmit power of the first transmission layer calculated based on the first power control parameter, and the transmit power of the second transmission layer calculated based on the second power control parameter. That is, the transmit power of the first transmission layer and the second transmission layer needs to be determined jointly, and when determining the actual transmit power of the first transmission layer, the transmit power of the second transmission layer also needs to be considered.

For the terminal device where the power can be shared between panels, may only limit total transmit power, and at this time, the terminal may prioritize distributing the power to a panel that needs more power according to the transmit power on two panels, thereby achieving better transmission performance. If a sum of maximum transmit power of a plurality of panels on a carrier exceeds maximum transmit power supported on the carrier, it is also necessary to use the second power control method to distribute the power among transmission layers of the plurality of panels.

In one implementation, the terminal device may determine the power control method according to its own terminal capability.

For example, if the power can not be shared between different panels of the terminal device, the first power control method is used; if the power can be shared between different panels of the terminal device, the second power control method is used. The terminal capability may be reported to the network device, so that the network device may know the power control method currently used by the terminal.

In another implementation, if the power can not be shared between different panels of the terminal device, the first power control method is used; if the power can be shared between different panels of the terminal, the first power control method or the second power control method may be used, and which method to use may be configured by the network device, or determined by the terminal device and then reported to the network device.

In another implementation, if the sum of the maximum transmit power supported by the terminal device on a plurality of panels on a carrier on which the PUSCH is located does not exceed the maximum transmit power supported on the carrier, the first power control method is used. If the sum of the maximum transmit power supported by the terminal device on the plurality of panels on a carrier on which the PUSCH is located exceeds the maximum transmit power supported on the carrier, the second power control method is used. Assuming that the maximum transmit power supported on a first panel is P_{c, 1, max}, the maximum transmit power supported on a second panel is P_{c, 2, max}, and the maximum transmit power supported by the terminal on the carrier is P_{c, max}, then when P_{c, 1, max}+P_{c, 2, max}<=P_{c, max}, the first power control method is used; when P_{c, 1, max}+P_{c, 2, max}>P_{c, max}, the second power control method is used.

In another implementation, the terminal device may determine the power control method according to indication information of the network device.

For example, the network device indicates a power control method currently used by the terminal device via the high layer signaling. For another example, the terminal device may only use the first power control method by default, and the network device may enable the second power control method via a downlink signaling, and when the terminal device receives the signaling, it uses the second power control method.

Before that, the terminal device also needs to report a first UE capability to the network device, and the first UE capability is used to indicate whether the power can be shared between different panels of the terminal device, and the network device may determine which power control method to use according to the capability reporting of the terminal device. If the first UE capability indicates that the power can be shared, the network device may configure the second power control method or the first power control method or may only configure the second power control method (at this time, the terminal does not expect that the network device configures the first power control method); if the first UE capability indicates that the power can not be shared, the network device can only configure the first power control method (at this time, the terminal does not expect that the network device configures the second power control method).

In addition, the terminal device may further report a second UE capability to the network device, the second UE capability is used to indicate at least one of: maximum transmit power supported by the terminal device on each panel of one carrier, maximum total transmit power supported by the terminal device on each panel, maximum transmit power supported by the terminal device on one carrier, or maximum total transmit power supported by the terminal on all panels. The maximum total transmit power supported on one panel herein refers to a total of maximum transmit power supported by one panel on all carriers, and the maximum total transmit power supported by the terminal on all panels is a maximum total of transmit power that the terminal can support on all panels and on the carrier on which the PUSCH is located, that is, the maximum transmit power supported by the terminal (i.e., transmit power determined by a power class of the terminal). The second UE capability may be used by the terminal to calculate the transmit power of the transmission layers associated with different SRI information under the first power control method.

In some implementations, the second UE capability may be reported to the network together with the first UE capability.

In one implementation, the terminal device reports the second UE capability only when the first UE capability reported by the terminal device indicates that the power can not be shared between different panels of the terminal.

S13, the terminal device obtains the transmit power of the transmission layers associated with the plurality of SRI information by using the determined power control method.

The method further includes, calculating by the terminal device, the PH values of the transmission layers associated with the plurality of SRI information according to the determined transmit power, and performs the PHR reporting. For example, the terminal device may perform the PHR reporting for the transmission layers associated with different SRI information, according to the used power control method. That is, for different power control methods, the corresponding PH value calculation formulas may be different.

In one implementation, if the terminal device performs the power control by using the first power control method, the PH value of the transmission layer may be calculated based on the maximum transmit power supported on each panel on the carrier on which the PUSCH is located and the transmit power of the transmission layer associated with each piece of SRI information; furthermore, the terminal device may report PHRs of transmission layers associated with the plurality of SRI information respectively. That is, the terminal device may calculate a PH value for a transmission layer associated with each piece of SRI information, and report these PH values respectively.

In another implementation, if the terminal device uses the second power control method, the PH value of the transmission layer may be calculated based on the maximum transmit power supported on the carrier on which the PUSCH is located and the transmit power of the transmission layer associated with each piece of SRI information; furthermore, the terminal device may report PHRs of transmission layers associated with the plurality of SRI information respectively.

S14, the terminal device transmits the plurality of transmission layers according to the determined transmit power.

Embodiment 2, the transmit power of the transmission layer may be determined and the transmission layer may be transmitted, for example, by S21 to S23.

S21, the terminal device receives DCI for scheduling the PUSCH, and the DCI contains a plurality of SRI information or a plurality of TCI states.

In this embodiment, the plurality of TCI states are taken as an example. Optionally, the TCI state in the following description in this embodiment may also be replaced with the SRI information, that is, the corresponding method may also be applied to the SRI information.

In this embodiment, the PUSCH contains a plurality of transmission layers (assuming that N>1 transmission layers herein), and the plurality of TCI states are associated with different transmission layers of the plurality of transmission layers (that is, different TCI states are associated with different transmission layers).

Herein, reference signal resources indicated by the plurality of TCI states belong to different reference signal resource sets. For example, SRS resources indicated by the plurality of TCI states belong to different SRS resource sets. The network device may pre-configure a plurality of SRS resource sets for the PUSCH, and each set is associated with one of the TCI states. For example, the TCI state indicates a CSI-RS resource, and CSI-RS resources indicated by the plurality of TCI states belong to different CSI-RS resource sets.

It needs to be noted that the association relationship may refer to the description of the above Embodiment 1, which will not be repeated here.

S22, the terminal device determines the transmit power of the transmission layers associated with the plurality of TCI states by using the first power control method;
where the first power control method is to determine the transmit power separately for transmission layers associated with different TCI states. For example, assuming that the DCI contains two TCI states (a first TCI state and a second TCI state), where the first TCI state is associated with a first transmission layer, and the second TCI state is associated with a second transmission layer (the subsequent description of this embodiment is illustrated by taking this assumption as an example). The transmit power of the first transmission layer is determined according to a first power control parameter corresponding to the first TCI state and the maximum transmit power of the first transmission layer (that is, on the panel on which the first transmission layer is located), and is independent from the transmit power of the second transmission layer; the transmit power of the second transmission layer is determined according to a second power control parameter corresponding to the second TCI state and the maximum transmit power of the second transmission layer (that is, on the panel on which the second transmission layer is located), and is independent from the transmit power of the first transmission layer.

In one implementation, the terminal device determines the transmit power corresponding to each of the plurality of TCI states according to a power control parameter corresponding to each of the plurality of TCI states and maximum transmit power supported on each panel on a carrier on which the PUSCH is located. Furthermore, the terminal device evenly distributes the determined transmit power corresponding to each TCI state to transmission layers associated with the TCI state.

For example, assuming that the transmit power determined according to the first power control parameter corresponding to the first TCI state is P₁, the transmit power determined according to the second power control parameter corresponding to the second TCI state is P₂, and the maximum transmit power supported by the terminal device on each panel on the carrier on which the PUSCH is located, is P_{c, p, max}, then total transmit power of the first transmission layer associated with the first TCI state (i.e., transmit power corresponding to the first TCI state) is P_{1, a}=min (P_{c, p, max}, P₁), and total transmit power of the second transmission layer associated with the second TCI state (i.e., transmit power corresponding to the second TCI state) is P_{2, a}=min (P_{c, p, max}, P₂). Furthermore, the terminal device evenly distributes P_{1, a} to the first transmission layer, and evenly distributes P_{2, a} to the second transmission layer. If there are n layers, a linear value of the transmit power of each layer is 1/n of the total power.

In one implementation, a sum of the maximum transmit power supported by the terminal device on a plurality of panels on the carrier on which the PUSCH is located is equal to the maximum transmit power supported on the carrier on which the PUSCH is located. For example, the terminal device has two panels, and the maximum transmit power supported on a first panel is P_{c, 1, max}, and the maximum transmit power supported on a second panel is P_{c, 2, max}, and the maximum transmit power supported by the terminal device on the carrier on which the PUSCH is located, is P_{c, max}, then P_{c, 1, max}+P_{c, 2, max}=P_{c, max}.

In another implementation, a sum of the maximum transmit power supported by the terminal device on a plurality of panels on the carrier on which the PUSCH is located, may also be less than or equal to the maximum transmit power supported on the carrier on which the PUSCH is located, that is, P_{c, 1, max}+P_{c, 2, max}<=P_{c, max}.

In one implementation, the DCI further contains a plurality of TPC commands, the plurality of TPC commands correspond one-to-one with the plurality of SRI information, and the plurality of TPC commands are used to indicate closed-loop power adjustment values of transmission layers associated with the corresponding SRI information. For example, the DCI contains a first TPC command and a second TPC command, the first TPC command corresponds to a first TCI state and is used to indicate a closed-loop power adjustment value of a first transmission layer; the second TPC command corresponds to a second TCI state and is used to indicate a closed-loop power adjustment value of a second transmission layer.

In one implementation, the transmission layers associated with a same TCI state or a same PTRS port use the same transmit power. For example, each TCI state may correspond to a PTRS port, so the transmission layers associated with the same PTRS port are the transmission layers associated with the same TCI state, which may use the same transmit power.

S23, the terminal device transmits the plurality of transmission layers according to the determined transmit power.

In a possible implementation, the terminal device transmits the transmission layers associated with different TCI states on different panels. For example, the terminal transmits a first transmission layer associated with a first TCI state, on a first panel, and transmits a second transmission layer associated with a second TCI state, on a second panel.

The method further includes, calculating by the terminal device, the PH value of the transmission layer according to the determined transmit power, and performing the PHR reporting.

In a possible implementation, the terminal device may calculate the PH value of the transmission layer based on the maximum transmit power supported on each panel on the carrier on which the PUSCH is located, and the transmit power of the transmission layer associated with each TCI state; furthermore, the terminal may report the PHRs of the transmission layers associated with the plurality of TCI states respectively.

For example, assuming that the transmit power of the first transmission layer associated with the first TCI state is P₁, the transmit power of the second transmission layer associated with the second TCI state is P₂, and the maximum transmit power supported by the terminal device on each panel on the carrier c on which the PUSCH is located, is P_{c, p, max}, then the PH value corresponding to the first transmission layer is P_{c, p, max}−P₁, and the PH value corresponding to the second transmission layer is P_{c, p, max}−P₂.

Embodiment 3, the transmit power of the transmission layer may be determined and the transmission layer may be transmitted, for example, by S31 to S33.

S31, the terminal device receives a DCI for scheduling the PUSCH, and the DCI contains a plurality of SRI information or a plurality of TCI states.

In this embodiment, the plurality of TCI states are taken as an example. Optionally, the TCI state in the following description in this embodiment may also be replaced with the SRI information, that is, the corresponding method may also be applied to the SRI information. The PUSCH contains a plurality of transmission layers (assuming that N>1 transmission layers herein), and the plurality of TCI states are associated with different transmission layers of the plurality of transmission layers (that is, different TCI states are associated with different transmission layers).

It needs to be noted that the association relationship may refer to the description of the embodiment 1, which will not be repeated here.

S32, the terminal device determines transmit power of transmission layers associated with the plurality of TCI states by using a second power control method.

In a possible implementation, the second power control method is to determine the transmit power jointly for transmission layers associated with different TCI states.

For example, assuming that the DCI contains two TCI states (a first TCI state and a second TCI state), where the first TCI state is associated with a first transmission layer, and the second TCI state is associated with a second transmission layer (the subsequent description of this embodiment is illustrated by using this assumption as an example). Herein, the first transmission layer is transmitted on a first panel, and the second transmission layer is transmitted on a second panel.

The terminal device may determine expected transmit power of the first transmission layer according to a first power control parameter corresponding to the first TCI state and the maximum transmit power on the carrier on which the PUSCH is located, and determine expected transmit power of the second transmission layer according to a second power control parameter corresponding to the second TCI state and the maximum transmit power on the carrier on which the PUSCH is located.

Furthermore, the terminal device may jointly determine actual transmit power of the first transmission layer and the second transmission layer, based on the expected transmit power of the first transmission layer and the second transmission layer, and the maximum transmit power supported on the carrier on which the PUSCH is located. That is, the transmit power of the first transmission layer and the second transmission layer needs to be jointly determined, and the terminal device may perform the power distribution between the first transmission layer and the second transmission layer (that is, between the first panel and the second panel).

In this embodiment, for the terminal device where the power can be shared between panels, only the total transmit power may be limited, and at this time, the terminal device may perform the power distribution between signals on two panels according to the expected transmit power on the two panels, and prioritize the distribution of the power to a panel that needs the power more among the two panels, thereby achieving the better transmission performance.

In one implementation, the terminal device determines the expected transmit power corresponding to each of the plurality of TCI states according to a power control parameter corresponding to each of the plurality of TCI states and the maximum transmit power supported on the carrier on which the PUSCH is located. Furthermore, the terminal device determines the transmit power of the transmission layers associated with different TCI states, according to the maximum transmit power supported on the carrier on which the PUSCH is located and the expected transmit power corresponding to each of the plurality of TCI states. In a possible implementation, there are three methods as follows.

Method 1: if a sum of the expected transmit power corresponding to the plurality of TCI states exceeds the maximum transmit power supported on the carrier, the terminal device reduces the transmit power corresponding to at least one of the TCI states according to a first preset rule, so that the sum of the transmit power corresponding to the plurality of TCI states does not exceed the maximum transmit power supported on the carrier on which the PUSCH is located; furthermore, the terminal device evenly distributes the transmit power to transmission layers associated with each of the TCI states.

Two TCI states are as an example for illustration herein, and assuming that the expected transmit power corresponding to a first TCI state is P₁, the expected transmit power corresponding to a second TCI state is P₂ and the maximum transmit power supported by the terminal device on the carrier on which the PUSCH is located, is P_{c, max}. In a case where P₁+P₂>P_{c, max} (assuming that all the power is linear value herein), the terminal device may reduce the transmit power corresponding to the first TCI state or the second TCI state according to the first preset rule, so that after the power reduction, P₁+P₂−P_{c, max}.

Furthermore, the terminal device evenly distributes P₁ to the first transmission layer, and evenly distributes P₂ to the second transmission layer. For example, assuming that the first transmission layer contains n transmission layers, a linear value of the transmit power of each layer is 1/n of the transmit power corresponding to the first TCI state.

Method 2: the terminal device determines a minimum value among the expected transmit power corresponding to the plurality of TCI states and the maximum transmit power supported on the carrier on which the PUSCH is located, as actual transmit power of the PUSCH, and evenly distributes the actual transmit power to all transmission layers contained in the PUSCH.

Assuming that the expected transmit power corresponding to the first TCI state is P₁, the expected transmit power corresponding to the second TCI state is P₂, and the maximum transmit power supported by the terminal device on the carrier on which the PUSCH is located, is P_{c, max}, then the actual transmit power of the PUSCH is min (P₁, P₂, P_{c, max}).

Method 3: the terminal device determines a smaller value between a maximum value among the expected transmit power corresponding to the plurality of TCI states and the maximum transmit power supported on the carrier on which the PUSCH is located, as actual transmit power of the PUSCH, and evenly distributes the actual transmit power to all transmission layers contained in the PUSCH.

Assuming that the expected transmit power corresponding to the first TCI state is P₁, the expected transmit power corresponding to the second TCI state is P₂, and the maximum transmit power supported by the terminal device on the carrier on which the PUSCH is located, is P_{c, max}, then the actual transmit power of the PUSCH is min (max (P₁, P₂), P_{c, max}).

In some implementations, the first preset rule includes at least one of the following five rules.

(1) Lowest transmit power among transmit power corresponding to the plurality of TCI states is reduced, that is, higher transmit power is not changed, thereby ensuring the transmission reliability of at least a part of the transmission layers.

Furthermore, if the lowest transmit power reaches a certain threshold value after the power reduction, the transmit power will not continue to be reduced, but the second lowest transmit power will be reduced, thereby ensuring that the transmit power corresponding to each TCI state has a minimum value that can support the transmission.

(2) Highest transmit power among transmit power corresponding to the plurality of TCI states is reduced, that is, lower transmit power is not changed, thereby ensuring that the transmission performance of all layers is similar.

Furthermore, if the highest transmit power is reduced to the same as transmit power corresponding to another TCI state, the transmit power corresponding to these two TCI states are reduced with a same ratio or with a same power value.

For example, after a first transmit power is reduced to the same as a second transmit power, and if the transmit power still needs to be reduced, these two transmit powers are reduced simultaneously, to ensure that the first transmit power is not less than the second transmit power after the power reduction, that is, only the currently highest transmit power is always reduced.

(3) If the transmission layer associated with the first TCI state contains HARQ-ACK information or CSI, and the transmission layer associated with the second TCI state does not contain the HARQ-ACK information and the CSI, the transmit power corresponding to the second TCI state is reduced.

In some implementations, if the transmission layer associated with the first TCI state contains the HARQ-ACK information, and the transmission layer associated with the second TCI state does not contain the HARQ-ACK information, the transmit power corresponding to the second TCI state is reduced.

In some other implementations, if the transmission layer associated with the first TCI state contains the CSI and the transmission layer associated with the second TCI state does not contain the CSI, the transmit power corresponding to the second TCI state is reduced.

(4) The transmit power corresponding to the plurality of TCI states is reduced with a same ratio.

For example, assuming that the expected transmit power of the plurality of panels is P₁ and P₂ respectively, and the maximum transmit power supported by the terminal on the carrier is Pₘₐₓ. In a case where P₁+P₂>Pₘₐₓ and signal priorities on the plurality of panels are the same, equally proportional reduction of the power on the plurality of panels is: P₁*Pₘₐₓ/(P₁+P₂) and P₂*Pₘₐₓ/(P₁+P₂), respectively.

(5) the transmit power corresponding to the plurality of TCI states is reduced with a same power value.

For example, assuming that the current transmit power of the PUSCH is P₂, the target transmit power is P₃ (P₃<P₂), and the DCI contains K TCI states, the transmit power corresponding to each TCI state needs to be reduced by (P₃−P₂)/K.

In this embodiment, if the transmit power of the transmission layer associated with a TCI state is lower than a preset first threshold value after reducing the transmit power, the PUSCH is not transmitted, or the transmission layer associated with the TCI state is not transmitted.

For example, if the transmit power of the first TCI state is lower than the first threshold value, the transmission layer associated with the first TCI state is not transmitted, and the transmission layer associated with the second TCI state may be transmitted or not.

In a possible implementation, the first threshold value is configured by the network device, or the first threshold value is reported to the network device by the terminal device by a UE capability.

Optionally, the first threshold value may be an absolute value of the transmit power (e.g., X dBm), or the first threshold value may be a ratio value (i.e., a value between 0 and 1) of the transmit power with respect to the maximum transmit power supported on one carrier. In one implementation, the DCI further includes a plurality of TPC commands, the plurality of TPC commands correspond one-to-one with the plurality of SRI information, and the plurality of TPC commands are used to indicate closed-loop power adjustment values of transmission layers associated with the corresponding SRI information. For example, the DCI contains a first TPC command and a second TPC command, the first TPC command corresponds to a first TCI state and is used to indicate a closed-loop power adjustment value of a first transmission layer; the second TPC command corresponds to a second TCI state and is used to indicate a closed-loop power adjustment value of a second transmission layer.

S33, the terminal device transmits the plurality of transmission layers according to the determined transmit power.

In a possible implementation, the terminal device transmits the transmission layers associated with different TCI states, on different panels. For example, the terminal device transmits the first transmission layer associated with the first TCI state, on the first panel, and transmits the second transmission layer associated with the second TCI state, on the second panel.

The method further includes, calculating by the terminal device, the PH value of the transmission layer according to the determined transmit power, and performing the PHR reporting.

In a possible implementation, the terminal device may calculate the PH value of the transmission layer based on the maximum transmit power supported on the carrier on which the PUSCH is located, and the transmit power of the transmission layer associated with each TCI state; furthermore, the terminal device may report the PHRs of the transmission layers associated with the plurality of TCI states respectively.

For example, assuming that the transmit power of the first transmission layer associated with the first TCI state is P₁, the transmit power of the second transmission layer associated with the second TCI state is P₂, and the maximum transmit power supported by the terminal device on the carrier on which the PUSCH is located, is P_{c, max}, then the PH value corresponding to the first transmission layer is P_{c, max}−P₁, and the PH value corresponding to the second transmission layer is P_{c, max}−P₂.

The method embodiments of the present disclosure are described in detail above with reference to FIG. 3 to FIG. 4, and apparatus embodiments of the present disclosure are described in detail below with reference to FIG. 5 to FIG. 6, and it should be understood that the apparatus embodiments and the method embodiments correspond to each other and the similar description may refer to the method embodiments.

FIG. 5 shows a schematic block diagram of a terminal device 400 according to the embodiments of the present disclosure. As shown in FIG. 5, the terminal device 400 includes: a communication unit 410, configured to receive a downlink signaling for scheduling a physical uplink shared channel (PUSCH); where the PUSCH includes a plurality of transmission layers, the downlink signaling includes a plurality of sounding reference signal resource indicator (SRI) information and the plurality of SRI information are associated with different transmission layers of the plurality of transmission layers, or the downlink signaling includes a plurality of transmission configuration indicator (TCI) states and the plurality of TCI states are associated with different transmission layers of the plurality of transmission layers;

a processing unit 420, configured to determine transmit power of the transmission layers associated with the plurality of SRI information or the plurality of TCI states by using a target power control method; where the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states;
the communication unit 410, further configured to transmit the plurality of transmission layers according to determined transmit power of the plurality of transmission layers.

In some embodiments, reference signal resources indicated by the plurality of SRI information belong to different reference signal resource sets, or reference signal resources indicated by the plurality of TCI states belong to different reference signal resource sets.

In some embodiments, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information; or in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

In some embodiments, the processing unit 420 is further configured to determine the target power control method, according to a terminal capability of the terminal device.

In some embodiments, the processing unit 420 is configured to:
in a case where the transmit power is not allowed to be shared between different antenna panels of the terminal device, determine that the target power control method is the first power control method; and/or
in a case where the transmit power is allowed to be shared between different antenna panels of the terminal device, determine that the target power control method is the second power control method.

In some embodiments, the processing unit 420 is configured to:
in a case where a sum of maximum transmit power supported by the terminal device on a plurality of antenna panels on a carrier on which the PUSCH is located does not exceed maximum transmit power supported on the carrier, determine that the target power control method is the first power control method; and/or
in a case where a sum of maximum transmit power supported by the terminal device on a plurality of antenna panels on a carrier on which the PUSCH is located exceeds maximum transmit power supported on the carrier, determine that the target power control method is the second power control method.

In some embodiments, the processing unit 420 is further configured to determine the target power control method, according to first indication information transmitted by a network device.

In some embodiments, before the terminal device receives the first indication information, the communication unit 410 is further configured to transmit first capability information to the network device, where the first capability information is used to indicate whether different antenna panels of the terminal device are allowed to share the transmit power.

In some embodiments, before the terminal device receives the first indication information, the communication unit 410 is further configured to transmit second capability information to the network device;
where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, or maximum total transmit power supported by the terminal device on all antenna panels.

In some embodiments, in a case where the target power control method is the first power control method, the processing unit 420 is configured to:
determine the transmit power corresponding to each of the plurality of SRI information, according to a power control parameter corresponding to each of the plurality of SRI information, and maximum transmit power supported by each antenna panel on a carrier on which the PUSCH is located; and distribute evenly the transmit power corresponding to each of the plurality of SRI information to transmission layers associated with each of the plurality of SRI information; or
determine the transmit power corresponding to each of the plurality of TCI states, according to a power control parameter corresponding to each of the plurality of TCI states, and maximum transmit power supported by each antenna panel on a carrier on which the PUSCH is located; and distribute evenly the transmit power corresponding to each of the plurality of TCI states to transmission layers associated with each of the plurality of TCI states.

In some embodiments, in a case where the target power control method is the second power control method, the processing unit 420 is configured to:
determine expected transmit power corresponding to each of the plurality of SRI information, according to a power control parameter corresponding to each of the plurality of SRI information and maximum transmit power supported on a carrier on which the PUSCH is located; and determine the transmit power of transmission layers associated with different SRI information according to the maximum transmit power supported on the carrier and the expected transmit power corresponding to each of the plurality of SRI information; or
determine expected transmit power corresponding to each of the plurality of TCI states, according to a power control parameter corresponding to each of the plurality of TCI states and maximum transmit power supported on a carrier on which the PUSCH is located; and determine the transmit power of transmission layers associated with different TCI states according to the maximum transmit power supported on the carrier and the expected transmit power corresponding to each of the plurality of TCI states.

In some embodiments, in a case where a sum of the expected transmit power corresponding to the plurality of SRI information exceeds the maximum transmit power supported on the carrier, the processing unit 420 is configured to:
reduce the expected transmit power corresponding to at least one of the plurality of SRI information according to a first preset rule, where a sum of transmit power corresponding to the plurality of SRI information after reducing the power does not exceed the maximum transmit power supported on the carrier; and distribute evenly transmit power corresponding to each of the plurality of SRI information after the reducing, to transmission layers associated with each of the plurality of SRI information.

In some embodiments, in a case where a sum of the expected transmit power corresponding to the plurality of TCI states exceeds the maximum transmit power supported on the carrier, the processing unit 420 is configured to:
reduce the expected transmit power corresponding to at least one of the plurality of TCI states according to a first preset rule, where a sum of transmit power corresponding to the plurality of TCI states after reducing the power does not exceed the maximum transmit power supported on the carrier; and distribute evenly the transmit power corresponding to each of the plurality of TCI states after the reducing, to transmission layers associated with each of the plurality of TCI states.

In some embodiments, the first preset rule includes at least one of:
reducing lowest transmit power among the transmit power corresponding to the plurality of SRI information or the plurality of TCI states;
reducing highest transmit power among the transmit power corresponding to the plurality of SRI information or the plurality of TCI states;
if a transmission layer associated with first SRI information among the plurality of SRI information includes hybrid automatic repeat request-acknowledgement (HARQ-ACK) information or channel state information (CSI), and a transmission layer associated with second SRI information among the plurality of SRI information does not include the HARQ-ACK information or the CSI, reducing transmit power corresponding to the second SRI information;
if a transmission layer associated with a first TCI state among the plurality of TCI states includes the HARQ-ACK information or the CSI, and a transmission layer associated with a second TCI state among the plurality of TCI states does not include the HARQ-ACK information or the CSI, reducing transmit power corresponding to the second TCI state;
reducing the transmit power corresponding to the plurality of SRI information or the plurality of TCI states with a same ratio; or
reducing the transmit power corresponding to the plurality of SRI information or the plurality of TCI states with a same power value.

In some embodiments, in a case where the transmit power of a transmission layer associated with one of the plurality of SRI information after reducing the transmit power is lower than a preset first threshold value, the terminal device does not transmit the PUSCH, or the terminal device does not transmit the transmission layer associated with the one of the plurality of SRI information.

In some embodiments, in a case where the transmit power of a transmission layer associated with one of the plurality of TCI states after reducing the transmit power is lower than a preset first threshold value, the terminal device does not transmit the PUSCH, or the terminal device does not transmit the transmission layer associated with the one of the plurality of TCI states.

In some embodiments, the first threshold value is configured by a network device, or the first threshold value is reported by the terminal device via a terminal capability to a network device.

In some embodiments, the processing unit 420 is configured to:
determine a minimum value among the expected transmit power corresponding to each of the plurality of SRI information and the maximum transmit power supported on the carrier, as actual transmit power of the PUSCH; and distribute evenly the actual transmit power of the PUSCH to all transmission layers included in the PUSCH; or
determine a smaller value between a maximum value among the expected transmit power corresponding to each of the plurality of SRI information and the maximum transmit power supported on the carrier, as actual transmit power of the PUSCH; and distribute evenly the actual transmit power of the PUSCH to all transmission layers included in the PUSCH.

In some embodiments, the processing unit 420 is configured to:
determine a minimum value among the expected transmit power corresponding to each of the plurality of TCI states and the maximum transmit power supported on the carrier, as actual transmit power of the PUSCH; and distribute evenly the actual transmit power of the PUSCH to all transmission layers included in the PUSCH; or
determine a smaller value between a maximum value among the expected transmit power corresponding to each of the plurality of TCI states and the maximum transmit power supported on the carrier, as actual transmit power of the PUSCH; and distribute evenly the actual transmit power of the PUSCH to all transmission layers included in the PUSCH.

In some embodiments, the communication unit 410 is further configured to perform power headroom report (PHR) reporting for transmission layers associated with different SRI information of the plurality of SRI information, according to the target power control method; or
the communication unit 410 is further configured to perform PHR reporting for transmission layers associated with different TCI states of the plurality of TCI states, according to the target power control method.

In some embodiments, in a case where the target power control method is the first power control method, the processing unit 420 is further configured to calculate a power headroom (PH) value of a transmission layer associated with each of the plurality of SRI information, according to maximum transmit power supported by each antenna panel on a carrier on which the PUSCH is located, and transmit power of the transmission layer associated with each of the plurality of SRI information; the communication unit 410 is further configured to report PHRs of the transmission layers associated with the plurality of SRI information respectively.

In some embodiments, in a case where the target power control method is the first power control method, the processing unit 420 is further configured to calculate a PH value of a transmission layer associated with each of the plurality of TCI states according to maximum transmit power supported by each antenna panel on a carrier on which the PUSCH is located and transmit power of the transmission layer associated with each of the plurality of TCI states; the communication unit 410 is further configured to report PHRs of the transmission layers associated with the plurality of TCI states respectively.

In some embodiments, in a case where the target power control method is the second power control method, the processing unit 420 is further configured to calculate a PH value of a transmission layer associated with each of the plurality of SRI information, according to maximum transmit power supported on a carrier on which the PUSCH is located, and transmit power of the transmission layer associated with each of the plurality of SRI information; the communication unit 410 is further configured to report PHRs of the transmission layers associated with the plurality of SRI information respectively.

In some embodiments, in a case where the target power control method is the second power control method, the processing unit 420 is further configured to calculate a PH value of a transmission layer associated with each of the plurality of TCI states, according to maximum transmit power supported on a carrier on which the PUSCH is located, and transmit power of the transmission layer associated with each of the plurality of TCI states; the communication unit 410 is further configured to report PHRs of the transmission layers associated with the plurality of TCI states respectively.

In some embodiments, the downlink signaling further includes a plurality of transmit power control (TPC) commands, the plurality of TPC commands correspond one-to-one with the plurality of SRI information or the plurality of TCI states, and the plurality of TPC commands are used to indicate power adjustment values of transmission layers associated with corresponding SRI information or TCI states.

In some embodiments, transmission layers associated with same SRI information use same transmit power, or transmission layers associated with a same TCI state use same transmit power, or transmission layers associated with a same phase tracking reference signal (PTRS) port use same transmit power.

In some embodiments, the communication unit 410 is configured to:
transmit transmission layers associated with different SRI information or TCI states, on different antenna panels.

In some embodiments, the above communication unit may be a communication interface or a transceiver, or an input/output interface of a communication chip or a system-on-chip. The above processing unit may be one or more processors.

It should be understood that the terminal device 400 according to the embodiments of the present disclosure may correspond to the terminal device of the method embodiments of the present disclosure, and the above and other operations and/or functions of various units in the terminal device 400 are respectively to implement the corresponding procedure of the terminal device in the method 200 shown in FIG. 3, which will not be repeated here for the sake of brevity.

FIG. 6 shows a schematic block diagram of a network device 500 according to the embodiments of the present disclosure. As shown in FIG. 6, the network device 500 includes:
a communication unit 510, configured to receive first capability information transmitted by a terminal device, where the first capability information is used to indicate whether transmit power is allowed to be shared between different antenna panels of the terminal device;

the communication unit 510, further configured to transmit configuration information to the terminal device according to the first capability information; where the configuration information is used to indicate that a first power control method or a second power control method is used for uplink power control, the first power control method is to determine the transmit power separately for transmission layers associated with a plurality of sounding reference signal resource indicator (SRI) information or a plurality of transmission configuration indicator (TCI) states, and the second power control method is to determine the transmit power jointly for the transmission layers associated with the plurality of SRI information or the plurality of TCI states; where a downlink signaling for scheduling a physical uplink shared channel (PUSCH) includes the plurality of SRI information or the plurality of TCI states, and the plurality of SRI information or the plurality of TCI states are associated with different transmission layers of a plurality of transmission layers of the PUSCH.

In some embodiments, reference signal resources indicated by the plurality of SRI information belong to different reference signal resource sets, or reference signal resources indicated by the plurality of TCI states belong to different reference signal resource sets.

In some embodiments, in a case where a number of SRI information of the plurality of SRI information is 2, a first half of transmission layers of the plurality of transmission layers are associated with one of the plurality of SRI information, and a second half of transmission layers of the plurality of transmission layers are associated with another of the plurality of SRI information; or
in a case where a number of TCI states of the plurality of TCI states is 2, a first half of transmission layers of the plurality of transmission layers are associated with one of the plurality of TCI states, and a second half of transmission layers of the plurality of transmission layers are associated with another of the plurality of TCI states.

In some embodiments, in a case where the first capability information indicates that the transmit power is allowed to be shared between different antenna panels of the terminal device, the network device configures the first power control method or the second power control method, or the network device only configures the second power control method; or in a case where the first capability information indicates that the transmit power is not allowed to be shared between different antenna panels of the terminal device, the network device only configures the first power control method.

In some embodiments, the network device receives second capability information transmitted by the terminal device, where the second capability information is used to indicate at least one of: maximum transmit power supported by the terminal device on each antenna panel of one carrier, maximum total transmit power supported by the terminal device on each antenna panel, maximum transmit power supported by the terminal device on one carrier, or maximum total transmit power supported by the terminal device on all antenna panels.

In some embodiments, in a case where a sum of maximum transmit power supported by the terminal device on a plurality of antenna panels on a carrier on which the PUSCH is located does not exceed maximum transmit power supported on the carrier, the network device only configures the first power control method; or
in a case where a sum of maximum transmit power supported by the terminal device on a plurality of antenna panels on a carrier on which the PUSCH is located exceeds maximum transmit power supported on the carrier, the network device configures the first power control method or the second power control method.

In some embodiments, the above communication unit may be a communication interface or a transceiver, or an input/output interface of a communication chip or a system-on-chip.

It should be understood that the network device 500 according to the embodiments of the present disclosure may correspond to the network device in the method embodiments of the present disclosure, and the above and other operations and/or functions of various units in the network device 500 are respectively to implement the corresponding procedure of the network device in the method 300 shown in FIG. 4, which will not be repeated here for the sake of brevity.

FIG. 7 is a schematic structural diagram of a communication device 600, provided by the embodiments of the present disclosure. The communication device 600 shown in FIG. 7 includes a processor 610. The processor 610 may invoke and execute a computer program from a memory to implement the method in the embodiments of the present disclosure.

In some embodiments, as shown in FIG. 7, the communication device 600 may further include a memory 620. Herein, the processor 610 may invoke and execute a computer program from the memory 620 to implement the method in the embodiments of the present disclosure.

Herein, the memory 620 may be a separate device independent from the processor 610, or may also be integrated into the processor 610.

In some embodiments, as shown in FIG. 7, the communication device 600 may also include a transceiver 630, and the processor 610 may control the transceiver 630 to communicate with other devices, and the transceiver 630 may send information or data to other devices, or receive information or data sent by other devices.

Herein, the transceiver 630 may include a transmitter and a receiver. The transceiver 630 may further include antennas, and the number of antennas may be one or more.

In some embodiments, the communication device 600 may be the network device of the embodiments of the present disclosure, and the communication device 600 may implement the corresponding procedure implemented by the network device in the various methods of the embodiments of the present disclosure, which will not be repeated here for the sake of brevity.

In some embodiments, the communication device 600 may be the terminal device of the embodiments of the present disclosure, and the communication device 600 may implement the corresponding procedures implemented by the terminal device in the various methods of the embodiments of the present disclosure, which will not be repeated here for the sake of brevity.

FIG. 8 is a schematic structural diagram of an apparatus of the embodiments of the present disclosure. The apparatus 700 shown in FIG. 8 includes a processor 710, the processor 710 may invoke and execute a computer program from a memory to implement the method in the embodiments of the present disclosure.

In some embodiments, as shown in FIG. 8, the apparatus 700 may further include a memory 720. Herein, the processor 710 may invoke and execute a computer program from the memory 720 to implement the method in the embodiments of the present disclosure.

Herein, the memory 720 may be a separate device independent from the processor 710, or may also be integrated into the processor 710.

In some embodiments, the apparatus 700 may further include an input interface 730. Herein, the processor 710 may control the input interface 730 to communicate with other devices or chips, and the input interface 730 may acquire information or data sent by other devices or chips.

In some embodiments, the apparatus 700 may further include an output interface 740. Herein, the processor 710 may control the output interface 740 to communicate with other devices or chips, and the output interface 740 may output information or data to other devices or chips.

In some embodiments, the apparatus may be applied to the network device in the embodiments of the present disclosure, and the apparatus may implement the corresponding procedure implemented by the network device in the various methods of the embodiments of the present disclosure, which will not be repeated here for the sake of brevity.

In some embodiments, the apparatus may be applied to the terminal device in the embodiments of the present disclosure, and the apparatus may implement the corresponding procedure implemented by terminal device in the various methods of the embodiments of the present disclosure, which will not be repeated here for the sake of brevity.

In some embodiments, the apparatus mentioned in the embodiments of the present disclosure may also be chip. For example, it may be a system on chip, a system chip, a chip system or a system-on-chip chip, etc.

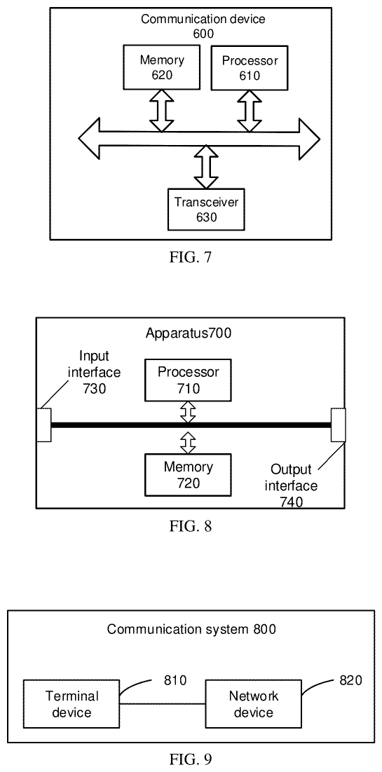

FIG. 9 is a schematic block diagram of a communication system 800, provided by the embodiments of the present disclosure. As shown in FIG. 9, the communication system 800 includes a terminal device 810 and a network device 820.

Herein, the terminal device 810 may be used to implement the corresponding functions implemented by the terminal device in the above method, and the network device 820 may be used to implement the corresponding functions implemented by the network device in the above method, which will not be repeated here for the sake of brevity.

It should be understood that the processor in the embodiments of the present disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that the memory in the embodiments of the present disclosure may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

The embodiments of the present disclosure further provide a non-transitory computer readable storage medium for storing a computer program.

In some embodiments, the non-transitory computer readable storage medium may be applied to the network device in the embodiments of the present disclosure, and the computer program causes a computer to perform the corresponding procedure implemented by the network device in the various methods of the embodiments of the present disclosure, which will not be repeated here for the sake of brevity.

In some embodiments, the non-transitory computer readable storage medium may be applied to the terminal device in the embodiments of the present disclosure, and the computer program causes a computer to perform the corresponding procedure implemented by the terminal device in various methods of the embodiments of the present disclosure, which will not be repeated here for the sake of brevity.

The embodiments of the present disclosure further provide a computer program product including a computer program instruction.

In some embodiments, the computer program product may be applied to the network device in the embodiments of the present disclosure, and the computer program instruction causes a computer to perform the corresponding procedure implemented by the network device in the various methods of the embodiments of the present disclosure, which will not be repeated here for the sake of brevity.

In some embodiments, the computer program product may be applied to the terminal device in the embodiments of the present disclosure, and the computer program instruction causes a computer to perform the corresponding procedure implemented by the terminal device in various methods of the embodiments of the present disclosure, which will not be repeated here for the sake of brevity.

The embodiments of the present disclosure further provide a computer program.

In some embodiments, the computer program may be applied to the network device in the embodiments of the present disclosure, the computer program when being executed on a computer, causes the computer to perform the corresponding procedure implemented by the network device in various methods of the embodiments of the present disclosure, which will not be repeated here for the sake of brevity.

In some embodiments, the computer program may be applied to the terminal device in the embodiments of the present disclosure, the computer program when being executed on a computer, causes the computer to perform the corresponding procedure implemented by the terminal device in various methods of the embodiments of the present disclosure, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in a form of a software functional unit and sold or used as an independent product, they may be stored in a non-transitory computer readable storage medium. For this understanding, the technical solution of the present disclosure essentially, or a part of the technical solution that contributes to the prior art, or a part of the technical solution, may be embodied in a form of a software product, and the computer software product is stored in a storage medium, and includes a plurality of instructions for enabling a computer device (which may be a personal computer, a server, or a network device, etc.) to perform all or some of steps of the methods described in the various embodiments of the present disclosure. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A method of wireless communication, comprising:
receiving by a terminal device, a downlink signaling for scheduling a physical uplink shared channel (PUSCH); wherein the PUSCH comprises a plurality of transmission layers, the downlink signaling comprises a plurality of sounding reference signal resource indicator (SRI) information and the plurality of SRI information are associated with different transmission layers of the plurality of transmission layers, or the downlink signaling comprises a plurality of transmission configuration indicator (TCI) states and the plurality of TCI states are associated with different transmission layers of the plurality of transmission layers;
determining by the terminal device, transmit power of the transmission layers associated with the plurality of SRI information or the plurality of TCI states by using a target power control method; wherein the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states;
transmitting by the terminal device, the plurality of transmission layers according to determined transmit power of the plurality of transmission layers.

2. The method according to claim 1, further comprising:
determining by the terminal device, the target power control method from the first power control method and the second power control method, according to first indication information transmitted by a network device.

3. The method according to claim 2, wherein before the terminal device receives the first indication information, the method further comprises:
transmitting by the terminal device, first capability information to the network device, wherein the first capability information is used to indicate whether different antenna panels of the terminal device are allowed to share the transmit power.

4. The method according to claim 1, wherein in a case where the target power control method is the first power control method, determining by the terminal device, the transmit power of the transmission layers associated with the plurality of SRI information or the plurality of TCI states by using the target power control method, comprises:
determining by the terminal device, the transmit power corresponding to each of the plurality of SRI information, according to a power control parameter corresponding to each of the plurality of SRI information, and maximum transmit power supported by each antenna panel on a carrier on which the PUSCH is located; and distributing evenly by the terminal device, the transmit power corresponding to each of the plurality of SRI information to transmission layers associated with each of the plurality of SRI information; or
determining by the terminal device, the transmit power corresponding to each of the plurality of TCI states, according to a power control parameter corresponding to each of the plurality of TCI states, and maximum transmit power supported by each antenna panel on a carrier on which the PUSCH is located; and distributing evenly by the terminal device, the transmit power corresponding to each of the plurality of TCI states to transmission layers associated with each of the plurality of TCI states.

5. The method according to claim 1, wherein in a case where the target power control method is the second power control method, determining by the terminal device, the transmit power of the transmission layers associated with the plurality of SRI information or the plurality of TCI states by using the target power control method, comprises:
determining by the terminal device, expected transmit power corresponding to each of the plurality of SRI information, according to a power control parameter corresponding to each of the plurality of SRI information and maximum transmit power supported on a carrier on which the PUSCH is located; and determining by the terminal device, the transmit power of transmission layers associated with different SRI information according to the maximum transmit power supported on the carrier and the expected transmit power corresponding to each of the plurality of SRI information; or
determining by the terminal device, expected transmit power corresponding to each of the plurality of TCI states, according to a power control parameter corresponding to each of the plurality of TCI states and maximum transmit power supported on a carrier on which the PUSCH is located; and determining by the terminal device, the transmit power of transmission layers associated with different TCI states according to the maximum transmit power supported on the carrier and the expected transmit power corresponding to each of the plurality of TCI states.

6. The method according to claim 5, wherein in a case where a sum of the expected transmit power corresponding to the plurality of TCI states exceeds the maximum transmit power supported on the carrier, determining by the terminal device, the transmit power of the transmission layers associated with different TCI states according to the maximum transmit power supported on the carrier and the expected transmit power corresponding to each of the plurality of TCI states, comprises:
reducing by the terminal device, the expected transmit power corresponding to at least one of the plurality of TCI states according to a first preset rule, wherein a sum of transmit power corresponding to the plurality of TCI states after reducing the power does not exceed the maximum transmit power supported on the carrier; and distributing evenly by the terminal device, the transmit power corresponding to each of the plurality of TCI states after the reducing, to transmission layers associated with each of the plurality of TCI states.

7. The method according to claim 6, wherein the first preset rule comprises at least one of:
reducing lowest transmit power among the transmit power corresponding to the plurality of SRI information or the plurality of TCI states;
reducing highest transmit power among the transmit power corresponding to the plurality of SRI information or the plurality of TCI states;
if a transmission layer associated with first SRI information among the plurality of SRI information comprises hybrid automatic repeat request-acknowledgement (HARQ-ACK) information or channel state information (CSI), and a transmission layer associated with second SRI information among the plurality of SRI information does not comprise the HARQ-ACK information or the CSI, reducing transmit power corresponding to the second SRI information;
if a transmission layer associated with a first TCI state among the plurality of TCI states comprises the HARQ-ACK information or the CSI, and a transmission layer associated with a second TCI state among the plurality of TCI states does not comprise the HARQ-ACK information or the CSI, reducing transmit power corresponding to the second TCI state;
reducing the transmit power corresponding to the plurality of SRI information or the plurality of TCI states with a same ratio; or
reducing the transmit power corresponding to the plurality of SRI information or the plurality of TCI states with a same power value.

8. The method according to claim 1, further comprising:
performing by the terminal device, power headroom report (PHR) reporting for transmission layers associated with different SRI information of the plurality of SRI information, according to the target power control method; or
performing by the terminal device, PHR reporting for transmission layers associated with different TCI states of the plurality of TCI states, according to the target power control method.

9. The method according to claim 8, wherein in a case where the target power control method is the first power control method, performing by the terminal device, the PHR reporting for the transmission layers associated with different TCI states of the plurality of TCI states, according to the target power control method, comprises:
calculating by the terminal device, a PH value of a transmission layer associated with each of the plurality of TCI states according to maximum transmit power supported by each antenna panel on a carrier on which the PUSCH is located and transmit power of the transmission layer associated with each of the plurality of TCI states; reporting by the terminal device, PHRs of the transmission layers associated with the plurality of TCI states respectively.

10. The method according to claim 8, wherein in a case where the target power control method is the second power control method, performing by the terminal device, the PHR reporting for the transmission layers associated with different TCI states of the plurality of TCI states, according to the target power control method, comprises:
calculating by the terminal device, a power headroom (PH) value of a transmission layer associated with each of the plurality of TCI states, according to maximum transmit power supported on a carrier on which the PUSCH is located, and transmit power of the transmission layer associated with each of the plurality of TCI states; reporting by the terminal device, PHRs of the transmission layers associated with the plurality of TCI states respectively.

11. A terminal device, comprising: a processor and a memory, wherein the memory is configured to store a computer program, the processor is configured to invoke and execute the computer program stored in the memory, to cause the terminal device to perform:
receiving a downlink signaling for scheduling a physical uplink shared channel (PUSCH); wherein the PUSCH comprises a plurality of transmission layers, the downlink signaling comprises a plurality of sounding reference signal resource indicator (SRI) information and the plurality of SRI information are associated with different transmission layers of the plurality of transmission layers, or the downlink signaling comprises a plurality of transmission configuration indicator (TCI) states and the plurality of TCI states are associated with different transmission layers of the plurality of transmission layers;
determining transmit power of the transmission layers associated with the plurality of SRI information or the plurality of TCI states by using a target power control method; wherein the target power control method is a first power control method or a second power control method, the first power control method is to determine the transmit power separately for the transmission layers associated with different SRI information or TCI states, and the second power control method is to determine the transmit power jointly for the transmission layers associated with different SRI information or TCI states;
transmitting the plurality of transmission layers according to determined transmit power of the plurality of transmission layers.

12. The terminal device according to claim 11, wherein the terminal device further performs:
determining the target power control method from the first power control method and the second power control method, according to first indication information transmitted by a network device.

13. The terminal device according to claim 12, wherein before the terminal device receives the first indication information, the terminal device further performs:
transmitting first capability information to the network device, wherein the first capability information is used to indicate whether different antenna panels of the terminal device are allowed to share the transmit power.

14. The terminal device according to claim 11, wherein in a case where the target power control method is the first power control method, determining the transmit power of the transmission layers associated with the plurality of SRI information or the plurality of TCI states by using the target power control method comprises:
determining the transmit power corresponding to each of the plurality of SRI information, according to a power control parameter corresponding to each of the plurality of SRI information, and maximum transmit power supported by each antenna panel on a carrier on which the PUSCH is located; and distributing evenly the transmit power corresponding to each of the plurality of SRI information to transmission layers associated with each of the plurality of SRI information; or
determining the transmit power corresponding to each of the plurality of TCI states, according to a power control parameter corresponding to each of the plurality of TCI states, and maximum transmit power supported by each antenna panel on a carrier on which the PUSCH is located; and distributing evenly the transmit power corresponding to each of the plurality of TCI states to transmission layers associated with each of the plurality of TCI states.

15. The terminal device according to claim 11, wherein in a case where the target power control method is the second power control method, determining the transmit power of the transmission layers associated with the plurality of SRI information or the plurality of TCI states by using the target power control method comprises:
determining expected transmit power corresponding to each of the plurality of SRI information, according to a power control parameter corresponding to each of the plurality of SRI information and maximum transmit power supported on a carrier on which the PUSCH is located; and determining the transmit power of transmission layers associated with different SRI information according to the maximum transmit power supported on the carrier and the expected transmit power corresponding to each of the plurality of SRI information; or
determining expected transmit power corresponding to each of the plurality of TCI states, according to a power control parameter corresponding to each of the plurality of TCI states and maximum transmit power supported on a carrier on which the PUSCH is located; and determining the transmit power of transmission layers associated with different TCI states according to the maximum transmit power supported on the carrier and the expected transmit power corresponding to each of the plurality of TCI states.

16. The terminal device according to claim 15, wherein in a case where a sum of the expected transmit power corresponding to the plurality of TCI states exceeds the maximum transmit power supported on the carrier, determining the transmit power of the transmission layers associated with different TCI states according to the maximum transmit power supported on the carrier and the expected transmit power corresponding to each of the plurality of TCI states, comprises:
reducing the expected transmit power corresponding to at least one of the plurality of TCI states according to a first preset rule, wherein a sum of transmit power corresponding to the plurality of TCI states after reducing the power does not exceed the maximum transmit power supported on the carrier; and distributing evenly the transmit power corresponding to each of the plurality of TCI states after the reducing, to transmission layers associated with each of the plurality of TCI states.

17. The terminal device according to claim 16, wherein the first preset rule comprises at least one of:
reducing lowest transmit power among the transmit power corresponding to the plurality of SRI information or the plurality of TCI states;
reducing highest transmit power among the transmit power corresponding to the plurality of SRI information or the plurality of TCI states;
if a transmission layer associated with first SRI information among the plurality of SRI information comprises hybrid automatic repeat request-acknowledgement (HARQ-ACK) information or channel state information (CSI), and a transmission layer associated with second SRI information among the plurality of SRI information does not comprise the HARQ-ACK information or the CSI, reducing transmit power corresponding to the second SRI information;
if a transmission layer associated with a first TCI state among the plurality of TCI states comprises the HARQ-ACK information or the CSI, and a transmission layer associated with a second TCI state among the plurality of TCI states does not comprise the HARQ-ACK information or the CSI, reducing transmit power corresponding to the second TCI state;
reducing the transmit power corresponding to the plurality of SRI information or the plurality of TCI states with a same ratio; or
reducing the transmit power corresponding to the plurality of SRI information or the plurality of TCI states with a same power value.

18. The terminal device according to claim 11, wherein the terminal device further performs:
performing power headroom report (PHR) reporting for transmission layers associated with different SRI information of the plurality of SRI information, according to the target power control method; or
performing PHR reporting for transmission layers associated with different TCI states of the plurality of TCI states, according to the target power control method.

19. The terminal device according to claim 18, wherein in a case where the target power control method is the first power control method, performing the PHR reporting for the transmission layers associated with different TCI states of the plurality of TCI states, according to the target power control method comprises:
calculating a power headroom (PH) value of a transmission layer associated with each of the plurality of TCI states according to maximum transmit power supported by each antenna panel on a carrier on which the PUSCH is located and transmit power of the transmission layer associated with each of the plurality of TCI states; reporting PHRs of the transmission layers associated with the plurality of TCI states respectively;
and/or,
in a case where the target power control method is the second power control method, performing the PHR reporting for the transmission layers associated with different TCI states of the plurality of TCI states, according to the target power control method comprises:
calculating a PH value of a transmission layer associated with each of the plurality of TCI states, according to maximum transmit power supported on a carrier on which the PUSCH is located, and transmit power of the transmission layer associated with each of the plurality of TCI states; reporting PHRs of the transmission layers associated with the plurality of TCI states respectively.

20. A network device, comprising: a processor and a memory, wherein the memory is configured to store a computer program, the processor is configured to invoke and execute the computer program stored in the memory, to cause the network device to perform:
receiving first capability information transmitted by a terminal device, wherein the first capability information is used to indicate whether transmit power is allowed to be shared between different antenna panels of the terminal device;
transmitting configuration information to the terminal device according to the first capability information; wherein the configuration information is used to indicate that a first power control method or a second power control method is used for uplink power control, the first power control method is to determine the transmit power separately for transmission layers associated with a plurality of sounding reference signal resource indicator (SRI) information or a plurality of transmission configuration indicator (TCI) states, and the second power control method is to determine the transmit power jointly for the transmission layers associated with the plurality of SRI information or the plurality of TCI states; wherein a downlink signaling for scheduling a physical uplink shared channel (PUSCH) comprises the plurality of SRI information or the plurality of TCI states, and the plurality of SRI information or the plurality of TCI states are associated with different transmission layers of a plurality of transmission layers of the PUSCH.
